(19) United States
(12) Patent Application Publication
(10) Pub. No.: US 2025/0373072 A1
(43) Pub. Date: Dec. 4, 2025

(54) HIGH SPEED-DATA ACQUISITION PROCESSING AND MACHINE LEARNING TELEMETRY PLATFORM

(71) Applicant: MICATU INC., Horseheads, NY (US)

(72) Inventors: Michael Oshetski, Horseheads, NY (US); Stephen Synakowski, Syracuse, NY (US); Stephen Waligurski, Cortland, NY (US); Bjorn Hansson, Trumansburg, NY (US); Alex Jones, Horseheads, NY (US); James Kennedy, Corning, NY (US); Atul Pradhan, Pittsford, NY (US)

(21) Appl. No.: 18/763,357

(22) Filed: Jul. 3, 2024

Related U.S. Application Data
(60) Provisional application No. 63/654,804, filed on May 31, 2024.

(51) Int. Cl. H02J 13/00

(52) U.S. Cl. CPC H02J 13/00002; H02J 13/00001; H02J 13/00006; H02J 2203/10

(57) ABSTRACT

A Grid Edge Platform or a processor board may be configured to monitor a utility grid and quickly determine or respond to a fault condition of the utility grid. The GEP may include a data acquisition system configured to acquire data from one or more sensors of the utility grid. The GEP may include a field-programmable gate array (FPGA) configured to manage the acquired data and to execute at least one algorithm using the acquired data. The GEP may include a graphics processing unit (GPU) configured to execute at least one machine learning algorithm on at least one of the acquired data or data processed by the FPGA. The GPU may be configured to output data to a remote system via an input/output system.

### CROSS-REFERENCE TO RELATED APPLICATION(S)

This application claims priority from U.S. Provisional Application No. 63/654,804, filed May 31, 2024, the disclosure of which is incorporated herein by reference in its entirety.

### TECHNICAL FIELD

The invention relates to the field of utility or power distribution grid management. It particularly relates to computing and data acquisition platforms capable of sensing and/or executing autonomous machine learning algorithms for real-time grid monitoring and anomaly detection on power systems having remote nodes and edge platforms located on utility grids.

### BACKGROUND

The traditional methods for utility grid monitoring involve manual data acquisition and analysis and remote, off-site data processing, often resulting in delayed responses to grid anomalies and faults. Existing systems lack the capability for real-time, in-situ data processing, and are not equipped with advanced machine learning algorithms for efficient and rapid anomaly detection and fault diagnosis. Data must therefore be sent to a remote system for processing, delaying fault detection and diagnosis. Using such traditional methods, a high voltage grid might not be shut down fast enough on a fault, which could cause severe damage.

Current standards require at most a 2-4 ms response and communication delay time to faults (per IEC-61850 Generic Object Oriented System-wide events or “GOOSE” protocol). One cycle of high voltage may be 20 ms or 16.67 ms, depending on geographic location. There is thus a need for a system that can quickly process data for fault determinations and can also comply with the time limits of the current standards and enhance safety.

### SUMMARY

In one aspect, a Grid Edge Platform (GEP) or a processor board may be configured to monitor a utility grid. The GEP may include and/or interface with a data acquisition system (DAQ) configured to acquire data from one or more sensors of the utility grid. The GEP may include a field-programmable gate array (FPGA) configured to manage the acquired data and to execute at least one algorithm using the acquired data. The GEP may include a graphics processing unit (GPU) configured to execute at least one machine learning algorithm on at least one of the acquired data or data processed by the FPGA. The GEP may include an input/output (I/O) system. The GPU may be configured to output data to a remote system via the I/O system.

The FPGA may be configured to output data via the I/O system. The FPGA may be configured to transfer data at high speed to the GPU for processing and/or analysis. The GPU may be configured to implement high speed Digital Signal Processing (DSP) and sampling. The GEP and/or the DAQ may be configured to use Nyquist sampling up to the 2500th harmonic. The system and/or the DAQ may be configured to use sampling bandwidths for vibration time scales that are greater than factor of 10 than aforementioned, and up to the 2500th harmonic. The GEP may be configured to use a 16 bit and an FPGA with processing speed in GHz greater than the max sampling.

The GPU may be configured to predict a future condition of the utility grid. The FPGA may be configured to detect an instant fault condition of the utility grid.

The data acquisition system may include a plurality of connected data acquisition (DAQ) cards. The DAQ cards may be configured to acquire data in a synchronous manner using Very High Speed Integrated Hardware Description Language (VHDL). The DAQ cards may include at least one of Analog to Digital Converters (ADC) and Digital to Analog Converters (DAC).

The GEP may include a plurality of radiating fins for heat dissipation.

The FPGA may be configured to output data via the input/output system.

The acquired data may include acquired input modulated analog signals. The FPGA may be configured to determine at least one of voltage, current, or phase based on the acquired input modulated analog signals. The acquired input modulated analog signals may include modulated light intensity.

The acquired data may include modulated light intensity. The FPGA may be configured to determine at least one of voltage, current, or optical phase based on the modulated light intensity.

At least one of the FPGA or the GPU may be configured to determine a fault condition of the utility grid based on the determined voltage, current, or optical phase.

The FPGA and/or the GPU may be configured to determine a fault condition of the utility grid in less than 2 milliseconds after the data may be acquired.

The GPU may be configured to determine at least one of a current fault condition of the utility grid or a predicted fault condition of the utility grid by executing the at least one machine learning algorithm. The FPGA may be configured to execute determinations by the GPU. For example, the FPGA may control or perform sectionalizing commands through DNP/SCADA, IEC-61850 (e.g., control the utility) and/or by activating LEA outputs for analog control signals.

The GPU may be configured for condition monitoring and machine learning in a distributed or cloud infrastructure. The GPU may include one or more machine learning applications that receives input, from the remote system, on the at least one machine learning algorithm. The GPU may be configured for more complex processing tasks, such as edge computing, machine learning, and/or artificial intelligence. The GPU may be configured to run anomaly detection algorithms, embedded edge algorithms for anomaly, fault detection, and condition monitoring. The GPU may be configured to generate high value data, such as fault determinations, real time load changes, grid balancing, and other grid optimization calculations by executing one or more machine learning, AI, etc. algorithms on the data received from the FPGA. The GPU may be configured to run software in Compute Unified Device Architecture (CUDA) for parallel computing. The GPU may be configured to transmit high value data to one or more external systems via an I/O system. The GPU may be configured to run one or more applications or apps, which may be remotely controlled by users via, for example, a web interface. The GPU may be configured to perform pre-defined operations without prompting or initiating by a third-party app. The GPU may include an internal memory, which may be connected to a high speed data bus. The GPU may be connected to a separate storage, such as a non-volatile memory express storage (NVMe storage) or NVRAM. The GPU may be connected to a serial communication device, such as RS232, configured to communicate system commands or queries.

The GEP may include a high speed data bus configured to transmit data from logic cells of the FPGA to a memory of the GPU. In some embodiments, a shared memory may be connected to the logic cells of the FPGA and a memory of the GPU. The GPU may be configured to identify data in the shared memory that requires machine learning processing and access the identified data.

The shared memory maybe configured for medium or long-term storage of data, such as logging data. The shared memory may include bandwidth of greater than 1.2 TB/s and at least 1024 Input/Output (I/O) pins, with a pin speed of more than 9.2 Gbps.

The FPGA may be configured to identify data required for processing by the at least one machine learning algorithm. The FPGA may be configured to send only the identified data to the GPU.

The I/O system may include a front plane including a plurality of input and/or output ports.

The GEP may include a main processor board configured to implement a preferred embodiment of an FPGA and GPU.

The GEP may be configured for high speed monitoring and detection of a utility power distribution grid. The GEP may be configured to acquire data. The GEP may be configured to determine voltage, current, and phase at each monitoring location from the acquired data. The GEP may be configured to process and/or output or present the determined voltage and/or current within distributed network protocol (DNP) and/or IEC-61850 protocols. The GEP may be configured to store the processed data in memory, in-situ, for grid monitoring applications. The grid monitoring applications may include fault and/or anomaly detection. The GEP may be configured to provide or forward processed data at high speed to a GPU for machine learning applications. The FPGA and the GPU may be configured to process large tranches of data and perform low-level computations, as well as run complex algorithms and programs on-site at the grid edge.

The GEP may be configured to be installed at an edge of a utility grid. The GEP may be configured to be installed at and/or mounted on a substation. The substation may include similar functionality as the GEP.

The GEP may be used in other power, current, or voltage monitoring systems, other utility systems, or even in other systems having other types of sensors, used in and/or based on a distributed grid or fleet such as environmental monitoring systems, automotive systems, and medical device systems.

The FPGA and the GPU may be provided on a same board.

The GEP may include or consist of a main board on which are surface mounted the FPGA, the processor board, a preferred embodiment herein being a Zynq Ultrascale System on Chip (SoC), and/or Multi-Processor System on Chip (MPSoC), and the GPU, in this embodiment being an NVIDIA Orin SOM.

The GEP may include a data acquisition system (DAQ) that provides a data feed to the FPGA.

The GEP may include a system on module SOM containing a GPU, and data may be supplied from the DAQ to the FPGA and GPU via shared memory.

A high speed direct memory bus may directly connect the FPGA and GPU.

The FPGA and GPU may be connected on output to specific hardware drivers and an ethernet port to an Input/Output (IO) system configured to output determinations to the cloud and/or an external server or network.

The DAQ may use a high-speed serial peripheral interface (SPI) for data acquisition. The SPI may operate in full duplex mode allowing data to be simultaneously sent and received.

The DAQ may be configured for rapid sampling to assist the GEP to quickly analyze data and thus enable the grid monitoring system to quickly and appropriately respond to utility grid events.

The DAQ may include a plurality of input channels.

The DAQ may include a board, a PCI-E connector at or adjacent with one or more analog cards connected to the board, and one or more Serial Peripheral Interface (SPI) to Analog cards, connected to the PCI-E connector and the FPGA. The DAQ may include one or more voltage regulators connected to the PCIE connector configured to regulate various voltages required for various chips and boards used in the main board. The one or more voltage regulators may be connected to voltage rails supplying DAQ cards and boards, as well as Lithium-Ion battery charging pack and/or external batteries and DC supplies.

The GEP may include one or more SPI to Analog cards that include at least one fast SPI to analog card configured for rapid sampling. At least one of the one or more sensors may be connected via a slow SPI to analog card for slower sampling than the fast SPI to analog card. The fast SPI to analog card may be configured to sample data for more time-sensitive determinations, such as voltage or current data from the one or more sensors for fault and/or anomaly detection.

The GEP may include an FPGA. The FPGA may manage SPI data acquisition, clock timing, and processing of the real-time, in-situ data acquired by the DAQ. The FPGA may be configured to manage data before sending data to the GPU and/or the shared memory. The FPGA may be configured to transmit data for processing or further processing to the shared memory and thence be accessible directly to the GPU.

The FPGA may be configured to use phase lock loop (PLL) detection methods based on a frequency of alternating current (AC) voltage and current signals of the one or more sensors. The FPGA may include a low energy analog (LEA) digital to analog converter (DAC) configured to represent determinations by the FPGA on a smaller scale.

The DAQ may be configured to implement low voltage differential signaling (LVDS), which is a paradigm for specifying the peripheral internal structure of a pin I/O list on FPGAs. The FPGA may be connected to various ports or devices of the I/O system and/or additional input/output devices, such as an LCD or keyboard, for setting parameters.

The FPGA may be connected to a switch between the FPGA and the GPU, which may be connected to the I/O system. The I/O system may include ethernet ports and/or optical ports. The one or more ethernet ports may be configured to support or implement General Packet Radio Service (GPRS) Tunneling Protocol (GTP). The FPGA and/or the GPU may be configured to open and/or close the switch to control data transmission to the ethernet ports and/or the optical ports. The I/O system may include two ethernet ports in a dual configuration. One ethernet port may be configured to be dedicated to outgoing transmission, and one ethernet port may be configured to be dedicated to incoming transmission.

The FPGA may be configured to transmit data to the cloud via the I/O system for long term storage. The GEP may be configured to communicate at high internet bandwidth rates rapidly with external systems and networks to relay information of power transmission for smart-grid, distributed machine learning, and artificial intelligence (AI) applications. The GEP may be a situationally aware system at a localized edge of a utility grid, enhancing safety to personnel and equipment for major transient and fault events. The GEP hardware may be configured to afford asynchronous to synchronous DAQ processing with algorithms, subroutine modules, and functions that may be placed on the ARM processor in the FPGA.

The I/O system may include one or more ethernet ports connected to the FPGA and/or the GPU, directly and/or via a switch, configured with high transceiver bandwidth sufficient to transmit high value data from the GPU to the cloud and other local or onsite devices. The I/O system may include one or more HDMI ports, one or more relays, a door switch, and one or more thermistors, etc.

The I/O system may be configured to transfer data from the GPU to an external or remote system such as the cloud and/or to other onsite systems such as a substation or a system controlling the utility grid.

In some embodiments, a utility grid monitoring device may include the processor board or GEP and the input/output system. The device may be configured to be installed at an edge of the utility grid.

In some embodiments, a utility grid monitoring system may include the utility grid monitoring device and the one or more sensors. The one or more sensors may include optical voltage sensors.

Embodiments disclosed herein may provide a grid edge monitoring device configured to monitor a utility grid. The grid edge monitoring device may include a housing and a processor board provided in the housing. The device may include a data acquisition system configured to acquire data from one or more sensors of the utility grid, a field-programmable gate array (FPGA) configured to manage the acquired data and to execute at least one algorithm using the acquired data, and a graphics processing unit (GPU) configured to execute at least one machine learning algorithm on at least one of the acquired data and/or data processed by the FPGA. The GPU may be configured to output data to a remote system via an input/output system.

The input/output system may be accessible from an external side of the housing. The device may include a plurality of analog card slots to receive data from a plurality of analog cards.

The housing may be configured to be installed at an edge of the utility grid. In some embodiments, the housing may be configured to be installed at a telephone pole.

Embodiments disclosed herein may include a grid monitoring system. The grid monitoring system may include one or more sensors and a grid monitoring device configured to monitor a utility grid. The grid monitoring device may include a housing and a processor board provided in the housing. The grid monitoring device may include a data acquisition system configured to acquire data from one or more sensors of the utility grid, a field-programmable gate array (FPGA) configured to manage the acquired data and to execute at least one algorithm using the acquired data, and a graphics processing unit (GPU) configured to receive data from the FPGA and to execute at least one machine learning algorithm on the received data. The GPU may be configured to output data to a remote system via an input/output system.

The one or more sensors may include one or more optical voltage sensors configured to detect a modulated light intensity. The FPGA may be configured, via an ARM processor, to determine at least one of an optical phase, current, or voltage based on detected modulated light intensity. The GPU may be configured to predict a condition of the utility grid based on the determined optical phase, current, or voltage.

The utility grid monitoring device may be provided at an edge of the utility grid. The at least one sensor and the utility grid monitoring device are provided on a telephone pole.

Embodiments disclosed herein may include a utility grid monitoring system. The utility grid monitoring system may include a plurality of sensors provided or deployed in a utility power distribution grid and a Grid Edge Platform (GEP) including a signal processor device. The plurality of sensors are configured to detect one or more parameters of the utility grid at one or more monitoring locations. The GEP may be configured to acquire data, including the one or more parameters, process the acquired data, store the processed data in memory, in-situ, for grid monitoring applications, and provide the processed data to a GPU for machine learning applications. The one or more parameters and/or the processed data may include voltage, current, phase angle, power factor, temperature, vibration, imaging using a camera, etc.

The GEP may be configured to determine voltage, current, and phase at each monitoring location from the acquired data. The GEP may be configured to process and output the determined voltage and current within Distributed Network Protocol (DNP) and IEC-61850 protocols.

The utility grid monitoring system may be provided at an edge of the utility grid and is configured to operate autonomously at the edge, on an edge platform, and/or among remote nodes of the utility grid.

The GEP may be configured for fault and anomaly detection of the utility power distribution grid.

The utility grid monitoring system may be configured to detect sudden changes, faults, tap changes, glitches, lightning strikes, etc. occurring in the utility grid or particular sections thereof. The utility grid monitoring system may be configured to enable quick, high-speed adjustment for shutting down of a power transmission line of a high voltage distribution grid upon detection of a fault or anomaly that could cause severe damage. The utility grid monitoring system may be configured to monitor conditions and/or predict future conditions of the utility grid. The GEP may be configured to be installed at and/or affixed to a pole connected to a power line. At least one of the plurality of sensors may be configured to detect one or more parameters from the power line.

The one or more sensors include one or more voltage sensors, vibration sensors, temperature sensors, etc. configured to detect voltage, current, temperature, etc. readings and to send signals to the GEP. The one or more sensors may include one or more optical voltage sensors configured to detect an electric field or voltage of the utility grid.

The one or more sensors may include non-optical sensors such as resistive dividers, capacitive sensors, etc. and include GPS systems, weather sensors, or other systems configured to send other types of data to the GEP.

The GEP may be configured to make determinations from data from the one or more sensors, perform both short-term and long-term monitoring, maintain a library of in situ data, calculate real time load changes, temperature changes, voltage changes, current changes, phase changes, and other parameters for balancing the grid and/or for fault detection or other unsafe conditions.

The GEP may be configured for grid optimization, such as to predict power consumption based on past trends. The GEP may be configured to transmit certain data to the substation or a system capable of shutting down the utility grid or decrease or increase power output or availability based on the calculations performed by the GEP. The GEP may be configured to implement edge computing to quickly prevent disaster based on thresholds of severity and continuous monitoring, and report to a main system details of the fault or anomaly, and/or execute preventive or mitigating actions. The GEP may be configured to comply with FCC, CE, and UL requirements and to perform extensive logging of captured data for plotting and troubleshooting in IEEE standard format COMTRADE files with sample rates up 300 kHz.

Embodiments disclosed herein may include a method of predicting a condition of a utility grid. The method may include acquiring, via a data acquisition system, data detected at the utility grid; executing, via a field programmable gate array provided on the processor board, at least one algorithm using the acquired data; executing, via the GPU, at least one machine learning algorithm on at least one of (a) data from the field programmable gate array and/or (b) the acquired data; predicting, via the GPU, a condition of the utility grid based on the execution of the at least one machine learning algorithm; and outputting the prediction to a remote system.

The FPGA may be configured to manage the acquired data and at least partially process the acquired data. The method may include identifying data required for machine learning. The method may include transmitting the identified data to a shared memory between the FPGA and the GPU, and/or the GPU.

The method may include periodically transmitting data from the FPGA to a shared memory between the FPGA and the GPU. The method may include identifying data in the shared memory required for machine learning. The method may include accessing, by the GPU, the identified data. The method may include executing the at least one machine learning algorithm includes executing a multivariate state estimation technique (MSET) algorithm.

Embodiments disclosed herein may include a method of monitoring a utility grid. The method may include acquiring, via a data acquisition system, data detected at the utility grid; executing, via a field programmable gate array provided on the processor board, at least one algorithm using the acquired data; executing, via the GPU, at least one machine learning algorithm on at least one of (a) data from the field programmable gate array and/or (b) the acquired data; determining a condition of the utility grid based on the execution of the at least one machine learning algorithm by the GPU and/or the at least one algorithm by the FPGA; and controlling the utility grid based on the determination. Determining the condition may include detecting a fault condition, and controlling the utility grid may include shutting down at least a section of the utility grid based on the detected fault detection. The fault condition may be transmitted to a substation that shuts down the section of the utility grid.

The FPGA may determine at least one FPGA value. The GPU may determine at least one GPU value based on execution of at least one machine learning algorithm. The GPU value may be indicative of a fault condition of a utility or power system or component. Determining the at least one GPU value includes comparing at least one intermediate value generated from the execution of the at least one machine learning algorithm to a threshold. The method may include outputting the FPGA and/or the GPU values to an external service, a remote physical location, or a cloud.

Embodiments disclosed herein may include a method of monitoring a utility grid. The method may include providing a machine learning algorithm to a grid monitoring system; receiving, from the grid monitoring system installed at a utility grid, a condition of the utility grid, the condition having been determined by the grid monitoring system executing at least one algorithm via a field programmable gate array and the provided machine learning algorithm via a graphics processing unit.

The method may include sending one or more commands to the grid monitoring system to control the utility grid. The received condition may include at least one of a detected fault of the utility grid or a prediction of a condition of the utility grid.

Embodiments disclosed herein may include a method for grid monitoring and/or controlling. The method may include acquiring data via a Grid Edge Platform (GEP), determining voltage, current, and phase at each monitoring location from the acquired data, processing and outputting and/or presenting the determined voltage and/or current with DNP and iEC-61850 protocols, storing the processed data in memory, in-situ, for grid monitoring applications such as fault and anomaly detection, and forwarding the processed data at high speed to a GPU for machine learning applications.

Embodiments disclosed herein may provide a system for monitoring and/or controlling power grid conditions. The system may include a main phase detection block. The main phase detection block may be configured to translate signals from sensors to a method of DAQ signals that have been detected and modulated by voltage and current sensors on the power distribution or utility grid.

The system may include an FPGA processing block. The FPGA processing block may be configured to receive and process data from various external interfaces, including but not limited to camera interfaces, keypads, GPS hardware, accelerometers, and internet/ethernet interfaces. The FPGA processing block may be configured to separate AC and DC signal data for use in various algorithms, and to digitize the data at a 16-bit level for precise grid mirroring. The FPGA processing block may be configured to sample signals synchronously and generate clock signals for signal processing algorithms.

The FPGA processing block may include a Xilinx Zynq Ultra-scale MPSoC and associated software/firmware suite, providing flexibility for upgrade, modification, and functionality.

The FPGA processing block may be configured to perform high-pass, low-pass, band-pass, and band-reject digital filtering.

The FPGA processing block may be configured to use the DNP Protocol and IEC 61850 standard for communication with various parties handling power grid data.

The FPGA processing block may be configured to identify data that requires further processing via artificial intelligence and/or machine learning algorithms, and to transmit the identified data for further processing. The FPGA processing block may be configured to transmit data directly to a GPU via a high speed direct memory data bus, or alternatively, to a shared memory, and the GPU may be configured to access the data in the shared memory transmitted by the FPGA.

The system may include a SPI interface. The SPI interface may have a maximum clock rate of 20 MHz, and optionally a Quad-SPI interface to handle more data in the same given time. The system may include a Low Voltage Differential Signaling (LVDS) setup to reduce noise and increase speeds to 100's of MHz.

The system may include a D/A conversion block that acts upon digital data derived from an FPGA processing block, supplying data points and LEA signals for a high voltage grid setup. The D/A conversion block may be configured to generate LEA signals representing grid conditions on the power grid and supplies oscillography.

The system may include a software and/or firmware block for output transmission to external systems, including several output mechanisms to transfer data. The software and/or firmware block may be configured to handle software and/or firmware with data access limited based on credentials and create development boards for end users based on an entire platform. The software may be configured to run in the “C” computer programming language, “Python,” and/or “VHDL” for use in the FPGA, and in “CUDA” (Computer Unified Device Architecture) per NVIDIA standards for use in parallel computing of a GPU or GPU's sensor input data.

The system may be configured to implement several methods of data storage, including NVMe and NVRAM, which are very fast storage interfaces used in software and/or firmware methods. The system may be configured to implement multiple channels, synchronous timing, and run machine learning firmware. The system and/or methods may not be limited to types of sensors and may implement other types of sensors requiring high speed data sampling and digital signal processing.

The system may include output mechanisms. The output mechanisms may include the LEA and FFT data to the GPU. The output mechanisms may use serial data communication from simple local RS232 to web-based serial protocols. Large quantities of shared RAM may be shared between the FPGA and the GPU, allowing each platform access to the same data for different processes required.

Embodiments disclosed herein may provide a high-speed data acquisition processing and machine learning telemetry platform that includes advanced computing, capable of operating autonomously at the edge and/or among remote nodes of a utility grid. The platform may be referred to as a Grid Edge Platform (GEP).

The GEP may provide hardware and software architecture outlines that enable edge computing, allowing major decisions on large amounts of high-speed data to be run locally, along with high value lower bandwidth data which are reported to cloud-based data asset and fleet systems.

The GEP may be combined with high-speed sensors, such as optical sensors measuring high voltage and current, to significantly reduce or effectively eliminate latency for the purposes of fault detection. The GEP may be configured to offer significant commercial applications, particularly in enhancing the accuracy of power consumption predictions. The GEP may integrate artificial intelligence, opening up numerous possibilities for cost savings and innovative data uses in the utility sector. The GEP may be configured to communicate at high speeds with enterprise networks and/or servers, enabling efficient data transmission and remote management with transceiver communication to cloud-based network and server assets.

Embodiments disclosed herein may provide a system on Chip (SoC) and/or System on Module (SOM) combinations or integrations of a programmable logic Floating Point Gate Array (FPGA) and one or more graphics processing units (GPUs). The GEP or board may be configured to utilize SoCs and SOMs and integrate several components, such as data acquisition systems, processing units, anomaly and fault detection firmware, communication interfaces, and/or for grid monitoring. The system may provide for a novel main microprocessor board that obviates a need for a backplane with all cards, SoCs, and SOMs, plugging directly into the main board, including critical Data Acquisition (DAQ) and Analog to Digital circuitry (ADC) that facilitate the capacity to manage this functionality using the FPGA.

The system may include a utility or electrical grid edge Digital Signal Processing (DSP), computing, and machine learning capable processing platform of real-time, in-situ signals data and oscillography.

The system may be configured to use a parallel processing Graphics Processing Unit (GPU) as a hardware adaptation that has this functionality in a deployed embedded platform, and incorporate it into embedded firmware for data and condition monitoring.

Embodiments disclosed herein may provide a high-speed data acquisition processing and machine learning telemetry platform that includes advanced computing, capable of operating autonomously at the edge and/or among remote nodes of a utility grid. The platform may be referred to as a Grid Edge Platform (GEP). The platform may provide hardware and software architecture outlines that enable edge computing, allowing major decisions on large amounts of high-speed data to be run locally, along with high value lower bandwidth data which are reported to cloud-based data asset and fleet systems.

The GEP may be configured to be combined with high-speed sensors, such as optical sensors measuring high voltage and current, to significantly reduce or effectively eliminate latency for the purposes of fault detection. The GEP may be configured to offer significant commercial applications, particularly in enhancing the accuracy of power consumption predictions. The GEP may be configured to integrate artificial intelligence, opening up numerous possibilities for cost savings and innovative data uses in the utility sector. The GEP may be configured to communicate at high speeds with enterprise networks and/or servers, enabling efficient data transmission and remote management with transceiver communication to cloud-based network and server assets.

Embodiments disclosed herein may provide a system on Chip (SoC) and System on Module (SOM) combinations or integrations. The SoC and/or SOM combinations may include of a programmable logic Floating Point Gate Array (FPGA) and one or more graphics processing units (GPUs). The GEP may be configured to utilize SoCs and SOMs and integrate several components, such as data acquisition systems, processing units, anomaly and fault detection firmware, communication interfaces, and/or for grid monitoring. The system may provide novel main microprocessor board that obviates a need for a backplane with all cards, SoCs, and SOMs, plugging directly into the main board, including critical Data Acquisition (DAQ) and Analog to Digital circuitry (ADC) that facilitate the capacity to manage this functionality using the FPGA. The system may include utility or electrical grid edge Digital Signal Processing (DSP), computing, and machine learning capable processing platform of real-time, in-situ signals data and oscillography.

The system may be configured to use a parallel processing Graphics Processing Unit (GPU) as a hardware adaptation that has this functionality in a deployed embedded platform and incorporate it into embedded firmware for data and condition monitoring.

Embodiments disclosed herein may provide a Grid Edge Platform. The GEP may include a computing and data acquisition platform configured to perform independent and autonomous machine learning at the edge and remote nodes of a utility or power distribution grid. The GEP may be configured to receive data from sensors onsite at the utility or power distribution grid and perform onsite data processing, at the grid edge, without needing to transmit data offsite to a remote processing system. The GEP may be configured to support high speed transceiver bandwidth to external cloud, enterprise, and Distributed Access Control System (DACS) servers.

Embodiments disclosed herein may provide a grid monitoring system. The grid monitoring system may include a plurality of line hanging sensors adapted to be connected to a power grid; a communication cable, preferably a fiber-optic cable, for connecting the line hanging sensors; an enclosure adapted to be mounted on a utility pole or tower, said enclosure housing: a Grid Edge Platform (GEP) device. The GEP device may include a Data Acquisition (DAQ) card system for acquiring data from the line hanging sensors; a Field-Programmable Gate Array (FPGA) for processing the acquired data; and a Graphics Processing Unit (GPU) for performing machine learning on the processed data; a memory unit for storing the acquired and processed data; and a heat dissipation system, preferably radiating fins. The GEP device may be further configured to determine voltage and current values based on the acquired data. The GEP device may be further configured to process and present the data in accordance with communication protocols, such as DNP3 and IEC-61850. The GEP device may be further configured to store the acquired and processed data in the memory unit for grid monitoring applications, such as fault and anomaly detection. The GEP device may be further configured to forward the acquired and processed data to the GPU for performing machine learning applications.

Embodiments disclosed herein may provide a Grid Edge Platform (GEP) device for a grid monitoring system. The GEP device may include a Data Acquisition (DAQ) card system for acquiring data from grid sensors, a Field-Programmable Gate Array (FPGA) for processing the acquired data, a Graphics Processing Unit (GPU) for performing machine learning on the processed data, a memory unit for storing the acquired and processed data, and a heat dissipation system, preferably radiating fins.

The device may be further configured to determine voltage and current values based on the acquired data. The device may be further configured to process and present the data in accordance with communication protocols, such as DNP3 and IEC-61850. The device may be further configured to store the acquired and processed data in the memory unit for grid monitoring applications, such as fault and anomaly detection. The device may be further configured to forward the acquired and processed data to the GPU for performing machine learning applications.

Embodiments disclosed herein may provide a grid monitoring system. The system may include one or more sensors configured to detect parameters of a utility grid and a signal processor device coupled to the one or more sensors. The signal processor device may include a field-programmable gate array (FPGA), a graphics processing unit (GPU), a shared memory, a high-speed direct memory bus, and an input/output (I/O) system. The FPGA may be configured to manage data acquisition from the one or more sensors, perform at least partially processing the data by implementing non-machine learning functions, and make determinations based on the data. The GPU may be configured to execute machine learning algorithms on the data to make determinations. The shared memory may be configured to store the data. The high-speed direct memory bus may connect the FPGA and the GPU to the shared memory. The I/O system may be configured to output the determinations to an external system.

The FPGA may be configured to perform temperature compensation on the data. The FPGA may be configured to determine at least one of voltage, current, phase angle, power factor, and differences in voltage, phase, and current.

The system may include a data acquisition system configured to acquire data from the one or more sensors. The data acquisition system may be configured for a sampling rate of at least 96 kHz.

The GEP may be configured to implement a low voltage differential signaling (LVDS) interface.

The system may include a low energy analog (LEA) digital to analog converter (DAC) configured to represent the determinations by the FPGA on a smaller scale.

Embodiments disclosed herein may provide a method for monitoring a utility grid. The method may include acquiring data from one or more sensors detecting parameters of the utility grid; processing the data in a signal processor device, the processing including at least partially processing the data by implementing non-machine learning functions in a field-programmable gate array (FPGA) of the signal processor device; executing machine learning algorithms on the data in a graphics processing unit (GPU) of the signal processor device; making determinations based on the processed data; and outputting the determinations to an external system.

### BRIEF DESCRIPTION OF THE DRAWINGS

The present invention is further described in the detailed description, which follows, in reference to the noted plurality of drawings by way of non-limiting examples of certain embodiments of the present invention, in which like numerals represent like elements throughout the several views of the drawings, and wherein:

FIG. 1 shows a grid monitoring system deployed on a utility pole and consisting of line hanging sensors connected by cables (in this case fiber-optic) to an enclosure mounted on the pole which contains the Grid Edge Platform (GEP). The pole or tower mounted system is part of a larger utility grid.

FIG. 2 shows an exploded view of a conceptual embodiment of a Grid Edge Platform (GEP) device consisting of connected Data Acquisition (DAQ) cards, an FPGA, and a GPU for condition monitoring and machine learning in a distributed or cloud data infrastructure. The device includes radiating fins for heat dissipation. The GEP device can also be mounted in a substation, with similar functionality.

FIG. 3 shows a block diagram for the main board of the GEP of FIG. 2 utilizing a preferred embodiment of an FPGA and GPU.

FIG. 4 shows a front panel layout of the GEP with input/output ports.

FIG. 5 illustrates an exemplary architecture for the GEP software functionality. This includes methods for acquiring the data, for determination of voltage and current, processing and presenting it within DNP and IEC-61850 protocols, and storing it in memory, in-situ, for grid monitoring applications such as fault and anomaly detection, and high speed forwarding to a GPU for machine learning applications.

### DETAILED DESCRIPTION

A detailed explanation of the apparatus, systems, methods, and exemplary embodiments of the present invention are described below. Numerous specific details are set forth in order to provide a thorough understanding of embodiments of the invention. However, it will be understood by ordinary artisans that embodiments of the present invention may be practiced without these specific details. In other instances, well-known methods, procedures, and components have not been described in detail so as not to obscure the present invention. Exemplary embodiments described, shown, and/or disclosed herein are not intended to limit any claim, but rather, are intended to instruct the ordinary artisan as to various aspects of the invention. Other embodiments can be practiced and/or implemented without departing from the scope and spirit of the invention.

High voltage grid monitoring systems that are presently utilized may have a field programmable gate array (FPGA) to manage the raw signal data acquired, while a central processing unit (CPU) may perform limited calculations on the acquired data. For example, current FPGAs typically use a digital signal processing block (DSP) that manages a serial peripheral interface (SPI) and routes raw data to the CPU. The FPGA may be configured for synchronous data acquisition and sampling communication, but is not capable of efficiently running machine learning algorithms. The CPU may perform relatively simple calculations on the raw data such as determining voltage, current, power, phase angle, power factor, and/or applying relatively simple functions such as temperature compensation functions, and filtering functions. However, the CPU is also not typically capable of running machine learning algorithms. Software in the CPU may convert the calculated data to a Distributed Network Protocol (DNP) format per Supervisory Control and Data Acquisition (SCADA) protocol for computer based systems. These present systems may be adapted only for SPI data processing and reporting voltage, current, power, phase angle, and power factor in DNP formats for SCADA. The exact speeds for data acquisition (DAQ) and communication can depend on the hardware capabilities and the design requirements associated with such legacy formats and protocols, but generally are not sufficient for real time, in-situ transmission to condition monitoring systems.

The disadvantages of these current systems is that data transfer through calculations at the CPU may be slow, clipping may occur at the digital signal processing (DSP) unit, and these systems are not capable of handling advanced machine learning or artificial intelligence algorithms. Thus, data from the CPU must generally be sent to external or remote offsite systems for more advanced calculations. As a result, fault detection is slow and may not be useful of timely response.

In addition, present and legacy high voltage grid monitoring systems may have electrical connections to the high voltage grid for sampling, creating a higher possibility of a lightning path. Sometimes, the high voltage may not be turned off on a fault and may cause fires and devastation. This failure to shutdown may be due to inadequate sensitivity or response time. Present and legacy attempts to further improve system response times and accuracy lack the sophistication and safety mechanisms required to safely avert disaster.

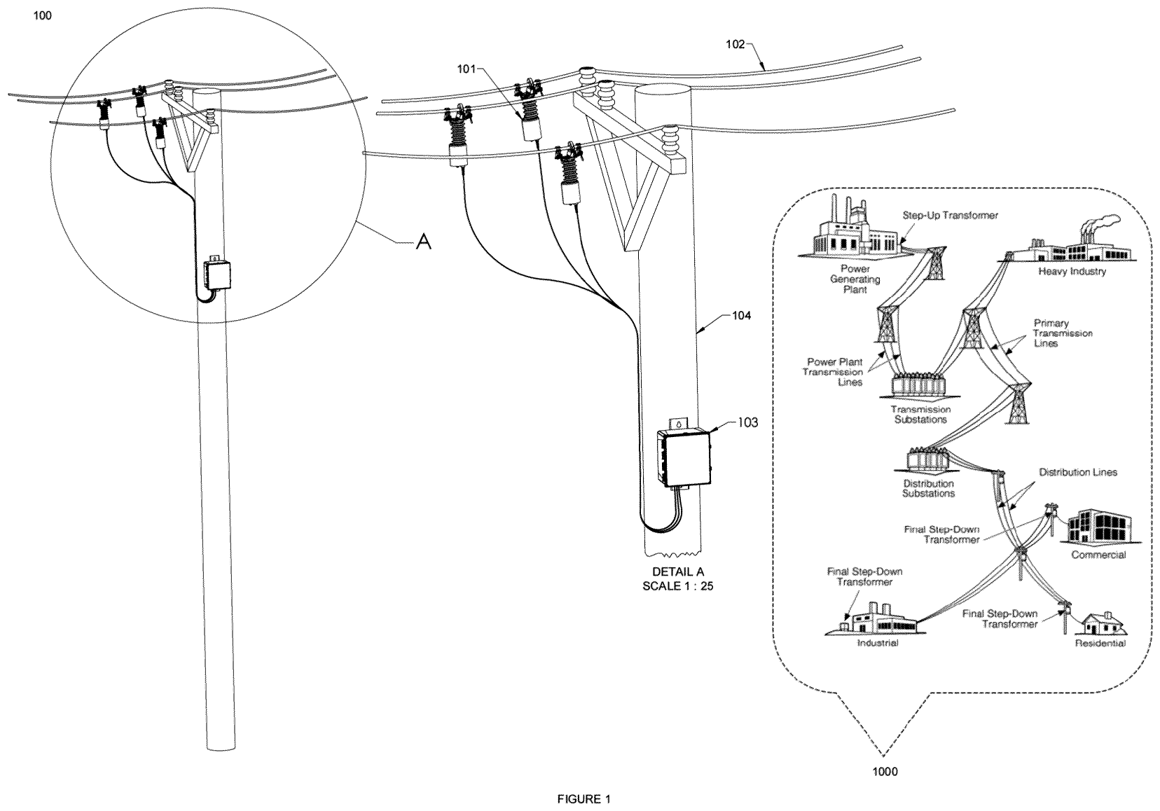

Aspects disclosed herein may detect sudden changes, faults, tap changes, and anomalies onsite to enhance grid function and integrity utilizing aspects disclosed herein that may incorporate fast sensors (e.g., such as all optical sensors). Referring to FIG. 1, a grid monitoring system 100 may monitor conditions (fault and anomaly detection, power consumption, etc.) and/or predict future conditions (e.g., future faults or power consumption) of a utility or power distribution grid 1000. The grid monitoring system 100 may be provided at an edge of the utility grid 1000 (e.g., on transmission lines of a synchronous power system) and may be configured to operate autonomously at the edge, on an edge platform, and/or among remote nodes of the utility grid 1000. For example, the grid monitoring system 100 may be provided at a tower, telephone pole, or underground. The grid monitoring system 100 may be connected to a substation or other device (not shown) configured to control the utility grid 1000. The grid monitoring system 100 may be configured to detect sudden changes, faults, tap changes, glitches, lightning strikes, etc. occurring in the utility grid 1000 or particular sections thereof. For example, the grid monitoring system 1000 may enable quick, high speed adjustment for shutting down of a power transmission line of a high voltage distribution grid upon detection of a fault or anomaly that could cause severe damage. A fast and efficient condition monitoring solution may therefore enhance this sectionalizing functionality.

The grid monitoring system 100 may include one or more sensors 101 coupled to (e.g., hanging on) a power line 102 configured to detect one or more parameters (voltage, current, phase angle, power factor, temperature, vibration, imaging using a camera, etc.) of the utility grid 1000, and a signal processor device or Grid Edge Platform (GEP) 103 that acquires and processes data from the sensors 101, enabling high speed monitoring and detection. Hereinafter, the signal processor device 103 may be referred to as the GEP in enclosure and is affixed to a pole 104 (e.g., telephone pole) connected to the power line 102.

The one or more sensors 102 may include, for example, one or more voltage sensors, vibration sensors, temperature sensors, etc. configured to detect voltage, current, temperature, etc. readings and to send signals (e.g., optical or electrical) to the GEP in enclosure 103. For example, the one or more sensors 102 may include one or more optical voltage sensors configured to detect an electric field or voltage of the utility grid 1000, such as the types of sensors described in U.S. Pat. No. 11,402,410 issued Aug. 2, 2022, which is incorporated by reference herein for its relevant teachings. Such sensors could be combinations of advanced optically based pockels high voltage sensors, such as those described in U.S. Pat. No. 10,663,494 issued May 26, 2020, faraday current sensors such as those described in U.S. Pat. No. 9,817,038 issued Nov. 14, 2017 (which are incorporated by reference herein for their relevant teachings), resistive dividers, capacitive sensors, temperature, vibration, as well as any other potential analog, mixed (A/D), or digital signal sensor used in electric grid monitoring.

For optical, optical fibers may transmit light to a high voltage line of the utility grid 1000 and modulated light back from the sensor 102 to provide a representation of line voltage, current, and phase angle. However, aspects disclosed herein are not limited one or more optical sensors, as said sensor 102 non-optical (e.g. resistive divider, capacitive, etc.) and include GPS systems, weather sensors, or other systems configured to send other types of data to the GEP in enclosure 103 fixed on a pole or tower 104. Although above-ground or overhead sensors 102 are illustrated as an example, the one or more sensors 102 illustrated herein are not limited to above-ground sensors. For example, the one or more sensors 102 may include underground sensors provided at an underground component (e.g., connector or load-break elbow) of the utility grid 1000. The one or more sensors 102 may be configured to be clamped on and removed from a component of the utility grid 1000, such as on an overhead line or cable, as aspects disclosed herein are not limited. The GEP in enclosure 103 may be coupled to the one or more sensors 102 (e.g., via wires). The GEP in enclosure 103 may be located at a same physical site (e.g., telephone pole) on the utility grid 1000 as the one or more sensors 102 to facilitate fast, in-situ acquisition and processing.

The GEP in enclosure 103 may be configured to make determinations (e.g., anomaly and fault detection) from data from the one or more sensors 102. The GEP in enclosure 103 may be configured for both short-term and long-term monitoring and maintain a library of in situ data that is stored on an electronic main board or peripherals. It may also be configured to calculate real time load changes, temperature changes, voltage changes, current changes, phase changes, and other parameters for balancing the grid and/or for fault detection or other unsafe conditions. The GEP in enclosure 103 may also be configured for grid optimization, such as to predict power consumption based on past trends. The GEP in enclosure 103 may be configured to transmit certain data to the substation or a system, for example, capable of shutting down the utility grid 1000 or decrease or increase power output or availability based on the calculations performed by the GEP in enclosure 103. Said GEP may therefore exhibit the functionality of a grid stabilizing sectionalizer. The GEP in enclosure 103 may further be configured to transmit certain data to external servers or networks for access by remote devices and/or users. It may be configured to implement edge computing to quickly prevent disaster based on thresholds of severity and continuous monitoring, and then report to a main system (e.g., the substation and/or remote systems) details of the fault or anomaly, and/or execute preventive or mitigating actions.

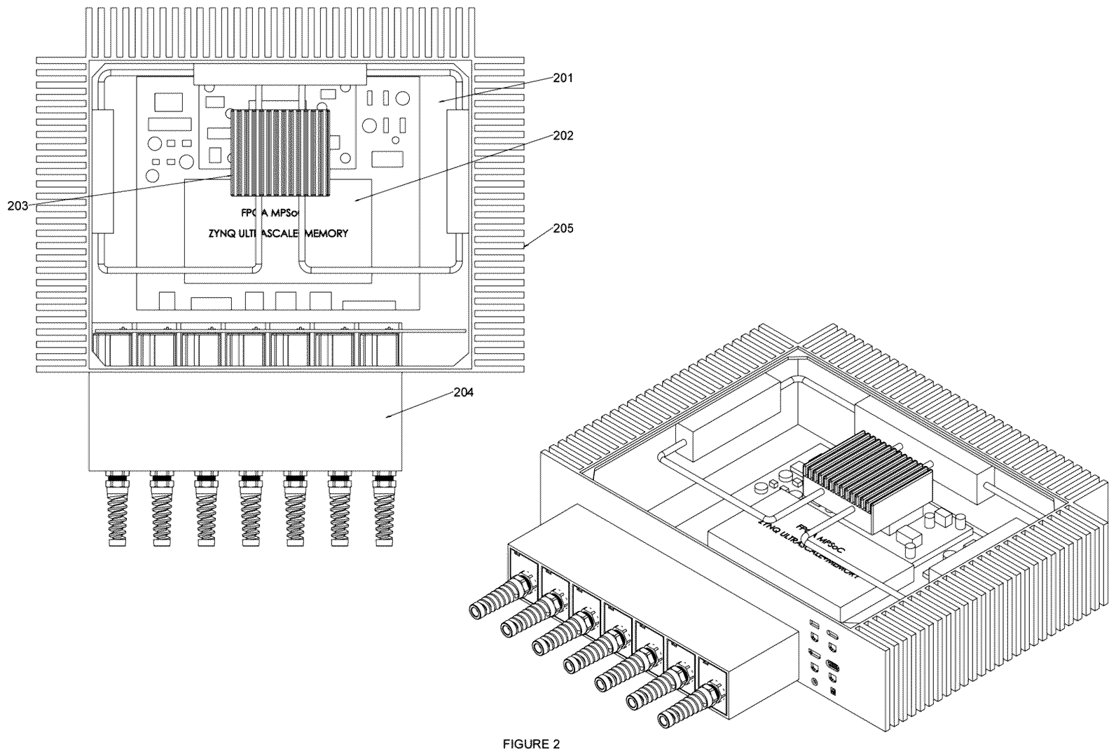

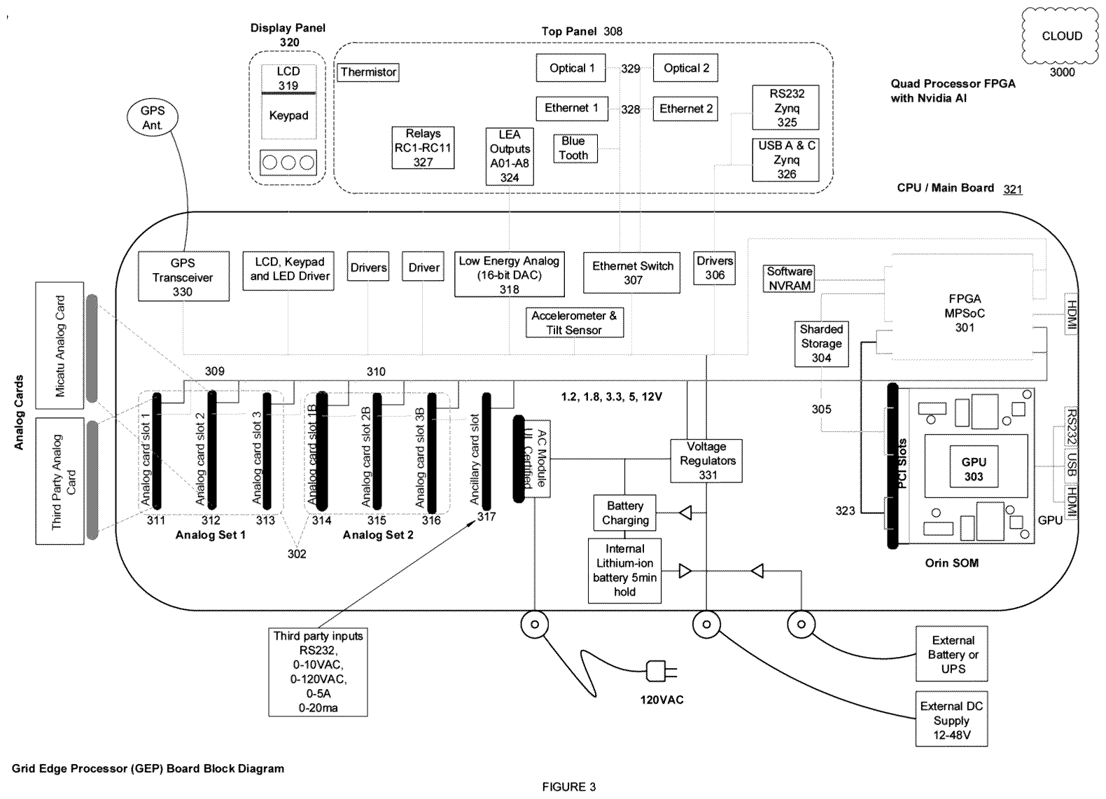

The GEP in enclosure 103 may comply with FCC, CE, and UL requirements and may be configured to perform extensive logging of captured data for plotting and troubleshooting in IEEE standard format COMTRADE files with sample rates up 300 kHz. The processed data may be output as oscillography from an output queue and sent in analog to LEA outputs, as will be described in more detail with reference to FIG. 3. The GEP in enclosure 103 and all of its components that will be described with reference to FIGS. 2 through 4 may have an industrial operating temperature rating of −40° C. to 85° C.

Referring to FIG. 2, the GEP in enclosure (103 of FIG. 1) consists of a main board 201, on which are surface mounted the FPGA 202, the processor board, a preferred embodiment herein being a Zynq Ultrascale System on Chip (SoC), and/or Multi-Processor System on Chip (MPSoC), and the GPU 203, in this embodiment being an NVIDIA Orin SOM. Other embodiments of FPGA are possible or desirable depending on requirements and applications. A series of boards 204 may be connected to the main board 201 and may include primary DAQ boards that connect to exemplary sensors, and may include other boards such as a temperature board, a power input board, an analog board, as well as other auxiliary boards. The main board 201 that includes the GEP may extend toward a front panel covering the main board 201 with its components. The main board 202 with GEP may be configured to perform operations on data received from the one or more sensors 102 through the DAQ 204 cards connected to the main board 202. For power dissipation, the GEP board can further be mounted in an encasement that has radiating heat fins 205. Also shown are input/output ports on the GEP that may be utilized.

FIG. 3 shows an exemplary block diagram implementation and high level schematic of the GEP board 300. The primary processing is performed by an SoC having FPGA functionality 301. The GEP board 300 includes a data acquisition system or DAQ 302 that provides a data feed to the FPGA 301. Also mounted on the GEP board 300 is an SOM containing a GPU 303. Data is supplied from the DAQ to the critical processing units, FPGA 301 and GPU 303 via shared memory 304. A high speed direct memory bus 305 directly connects the FPGA 301 and GPU 303, and the GEP board 300 may include only one of a plurality of shared memories 304, FPGAs 301s, GPUs 303, high speed direct memory buses 305 connecting the FPGAs 301s to the GPU 303s, and/or connecting the FPGAs 301s and GPUs 303 to a shared memory.

The FPGA 301 and GPU 303 are connected on output to specific hardware drivers 306 and an ethernet port 307 to an Input/Output (IO) system 308 configured to output determinations to the cloud 3000 and/or an external server or network. The DAQ 302 may use a high speed serial peripheral interface (SPI) for data acquisition, and the FPGA 301 may receive, in a synchronous fashion, raw or digitized data, e.g., data digitized on the board 309, and/or via a SPI serial stream input implementing LVDS, and also may implement a version of the interface framework JESD204. From the DAQ 302, it may perform one or more calculations or processing functions on the received data. The FPGA 301 may send partially processed data to a shared memory 304 and/or directly to the GPU 303 via the high speed direct memory bus 305. The GPU 303 may execute one or more machine learning algorithms on the data received from the FPGA 301 and/or accessed in the shared memory 304 to make one or more determinations (e.g., whether a fault exists). The GPU 303 may output its determinations via the I/O system 308. These determinations may be further output to an external system, such as to a substation (not shown) connected to the GEP 300 via ethernet or other fiber optics, wireless, or satellite, to the cloud 3000, and to other external networks and/or servers. The data on the cloud 3000 may be accessed from different physical locations other than the GEP 300, for example via a web interface on a computer at a different physical location.

The DAQ 302 may be configured to receive data from the one or more sensors 101 (FIG. 1). For example, the DAQ 302 may be connected, via wires, fiber optics, etc., to the one or more sensors (of FIG. 1, 101) and/or to other systems configured to provide information such as positioning systems (e.g., GPS), time and date systems, weather systems or databases, etc. The DAQ 302 may be configured for synchronous data sampling so that the FPGA may receive multiple data signals for a given time, such as three signals related to three phases of a three-phase power line.

The DAQ 302 may be configured for rapid sampling to assist the GEP 300 to quickly analyze data (e.g., fault detection) and thus enable the grid monitoring system (100, of FIG. 1) to quickly and appropriately respond to utility grid events. Primary voltage and current frequency oscillography profiles may be configured for transmission, along with configurations to detect transients and harmonics associated with fault and anomaly events, as these features may provide a unique signature of event.

For example, a 60 Hz line frequency may be configured to discern the 50th harmonic, and the DAQ 302 may sample at a rate at least fifty (50) times the line frequency times a multiple of the Nyquist criteria (2) to sample and observe a high harmonic. For a multiple of sixteen (16) data points per highest harmonic, this may mean a sampling rate of at least 96 Kilo-Samples/sec (KS/sec). Mathematically, the DAQ 302 may be configured for sampling at 60 Hz×50th Harmonic×2×m Kilo Samples/sec (KS/sec), where m is a minimum multiple above Nyquist (e.g., 60*50*2*8 or 48 KS/sec, for m=8). This number may be multiplied by 2 for an additional margin (e.g., 96 KS/sec) of error fidelity in the DSP and associated oscillography.

The DAQ 302 may implement events at a higher sampling speed depending on the type of sensor 102. For example, the DAQ 302 may include a sampling rate of 1 MS/sec for a vibration sensor with 10 Khz bandwidth for which Nyquist fidelity is required up to the 50th harmonic. A vibration sensor with 10 Khz bandwidth, for which harmonic fidelity 5 orders above Nyquist may be needed (e.g. 2\hat{ }5=32), and may require a factor of 32 times the highest fundamental frequency or 320 Khz. Although certain sampling speeds are provided herein, aspects disclosed herein are not limited to specific sampling speeds. Said GEP may have, as input, multiple advanced sensor inputs routed over high speed SPI that may support utility and distribution networks signals and factors at speeds significantly greater than twice the Nyquist frequent of AC transmission of power.

The DAQ 302 may include a plurality of input channels. For example, the DAQ 302 may include three input channels for each of voltage and current in a 3-phase AC transmission system with relative sequential phase angle separations of 120 degrees of phase, resulting in 6 DAQ input channels. The DAQ 302 may include a board 309, a PCI-E connector 310 at or adjacent with one or more analog cards 311-316 connected to the board 309, and one or more Serial Peripheral Interface (SPI) to Analog cards, 311-316, connected to the PCI-E connector 310 and the FPGA 301.

The one or more analog cards 311, 312, 313, 314, 315, 316, and ancillary card 317, connected to the board 309 may provide data (e.g., raw data or alternatively partially processed data) from the one or more sensors (101 of FIG. 1) to the backplane 309. The one or more analog cards 311-316, and ancillary card 317 may use a Low Voltage Differential Signaling (LVDS) interface for connecting to the board 309.

As an example, the one or more sensors 101 may include three sensors, and the one or more analog cards may include three analog cards corresponding to three sensors voltage sensors and three current sensors attached to a power distribution three-phase power line. The one or more sensors 101 may also include additional sensors or data detection systems, including sensors provided by third parties, positioning systems (e.g., GPS), time and date systems, etc. associated with an additional card slot (317). Although seven analog cards are shown, aspects disclosed herein do not limit the number of analog cards. The data from the one or more analog cards may be routed on or through the board 309 and/or digitized at the board via a DAQ SPI serial stream input and sent to the one or more SPI to Analog cards 311-316, and ancillary card 317.

The one or more SPI to Analog cards 311-317, and ancillary card 317, may include at least one fast SPI to analog card that corresponds to the one or more sensors (101 of FIG. 1). Such a fast SPI to analog card may be configured for rapid sampling, such as in a range of 15 khz-30 khz, or even 300 khz or more if higher harmonic content is desired. The one or more sensors 101 may be connected via a slow SPI to analog card for slower sampling than the fast SPI to analog card, such as in a range of [10-100 Hz]. The fast SPI to analog card may be configured to sample data for more time-sensitive determinations, such as voltage or current data from the one or more sensors 101 for fault and/or anomaly detection, while the slow SPI to analog card 314 may be configured to sample data for less time-sensitive determinations, such as temperature, supply voltage, longer-term error checks, etc. The sampling rates may be determined based on a type of sensor 101 and/or other design considerations.

An arrangement of the one or more analog cards 311-316 and the one or more SPI to analog cards of the DAQ 302 may provide a high speed serial peripheral interface (SPI) for data acquisition. This SPI may operate in full duplex mode, allowing data to be simultaneously sent and received and may be implemented at higher clock speeds than standard SPI interfaces, such as from 16 MHz max of standard SPI, to four times that data rate, equivalent to 64 MHz SPI. This is due to four data lines as opposed to two, and the ability to use rising and falling clock edges, with the DAQ 302 configured to acquire data in the millisecond and sub-millisecond time domains. The clock speeds of the SPI protocol may be determined based on hardware capabilities and design requirements.

Higher data acquisition speeds may be realized with the implementation of JESD204 and associated data acquisition integrated circuits. This data acquisition framework facilitates higher bandwidth capability than standard or legacy DAQ frameworks or protocols utilizing LVDS and SERDES (deserialization/deserialization) techniques. JESD204 capable DAQ IC's (analog to digital and digital to analog converters) are typically used, however this framework can be added to the FPGA as an instantiated internal block. The JESD204 interface is a standardized serial interface developed by the JEDEC committee used by data converters (ADCs and DACs) and logic devices such as FPGAs supporting serial data rates up to 12.5 Gbps. It affords benefits such as reduced/simplified PCB area, smaller package size, comparable power consumption for large throughput, scalability to higher frequencies and sampling, simplified interface timing, standardized interfaces, multi-lane synchronization, and deterministic latency.

The FPGA 301 may manage the SPI data acquisition, clock timing, and processing of the real-time, in-situ data acquired by DAQ 302. The FPGA may be configured to include sufficient memory resources and implement clock timing bandwidths that can manage peripheral devices quickly, such as I/O analog, digital, and/or mixed signal through SPI configurations and protocols. The FPGA 301 may receive, in synchronous fashion, the data from the DAQ 302 and be configured for parallel processing.

The design architecture of the FPGA 301 may be programmed to clock the SPI of the analog to digital A/D converters, and digital to analog D/A converters in a synchronous fashion in lock step with each other. For example, the design architecture of the FPGA 301 may be programmed using Very High Speed Hardware Description Language (VHDL), but aspects disclosed herein are not limited. In addition to VHDL, software for use in the FPGA 301 may be run in C and/or Python languages. The FPGA 301 may receive or access, from the DAQ 302, data that is digitized. Alternatively or in addition thereto, the FPGA 301 may receive analog or mixed signal data, and may digitize the data via one or more analog to digital converters.

The FPGA 301 may use phase lock loop (PLL) detection methods based on the frequency of AC voltage and current signals of one or more sensors (101 of FIG. 1). The FPGA 301 may also manage the SPI data acquisition of the DAQ 302 for outgoing controlling of functions such as when the one or more sensors includes one or more optical sensors having a pockels crystal. In such cases, SPI may be used for controlling functions relating to optical fiber LED or laser light modulation to allow for phase PLL biasing schemes.

The DAQ 302 and/or the FPGA 301 may implement low voltage LVDS which is a paradigm for specifying the peripheral internal structure of a pin I/O list on FPGAs. Since differential nets are routed parallel to each other, the pin I/Os may reduce routing constraints as impedance matching is no longer a requirement. An FPGA 301 may have internal LVDS capability, so that Transistor-Transistor Logic (TTL) to LVDS transceiver chips are not necessary and may be omitted. This provides advantageous capabilities, as LVDS can allow for very high data speeds (e.g., 100's of MHz). The FPGA may use a serializer-deserializer (SerDes) multi-channel interface to reduce circuit nets for many ADC channels. The FPGA 301 may include a processor, such as an advanced reduced instruction set computer (RISC) machine (ARM) core or processor. Unlike present or legacy grid monitoring systems, however, the ARM of the FPGA 301 herein is not only configured to manage data (e.g., managing enhanced direct memory access (EDMA) timing), but to also at least partially process the data by implementing non-machine learning functions such as temperature compensation and/or determining voltage, current, phase angle, differences in voltage, phase, and/or current, temperatures of sensors (101 in FIG. 1), communication and configuration of various boards (e.g., the plurality of boards, analog, or main board in FIG. 2), and line temperatures from the utility grid 1000, etc. from the data received from the DAQ 302. One or more algorithms (e.g., temperature compensation, fourier transform, Laplace transform, or other DSP algorithms) for such data processing may be placed on the ARM. The ARM may be an integrated circuit, hard core, and/or may be a soft ARM core. The FPGA 301 may include many logic cells (e.g. 100,000 logic cells), in the preferred embodiment of utilizing a high integration Zynq Ultrascale SoC, and/or MPSoC.

The FPGA 301 may also include a low energy analog (LEA) digital to analog converter (DAC) 318. The LEA DAC 318 may be configured to represent determinations by the FPGA 301 on a smaller scale. For example, the LEA DAC may convert voltage readings typical of the utility grid (1000 or FIG. 1) on the order of several thousand, tens of thousands, or hundreds of thousands of volts down by a factor of, for example, of several thousands, and thus represent these voltage readings to, for example, voltage readings on the order and/or scale of 15 volts. The readings may reflect real time readings such as a waveform but on a smaller scale. The LEA DAC 318 may facilitate fast, real time readings for high speed sampled data and may continuously represent these readings so that other devices (e.g., devices connected to the I/O system 308 or the GPU 303) may quickly assess determinations by the FPGA 301 of critical in-situ quantities such as the power factor (voltage multiplied by current) and phase angle between voltage and current.

The FPGA 301 may further be connected to various ports or devices of the I/O system 308, and/or additional input/output devices 319, such as an LCD or keyboard, for setting parameters. The additional input/output devices 319 may be accessible from an exterior side of the front panel 320 (the touchscreen, keypad, and LEDs) and/or on a panel of a door of the GEP (103 of FIG. 1). The FPGA 301 may be connected to a switch 307 between the FPGA 301 and the GPU 303, which may be connected to the I/O system 308 as described in more detail later. The switch 307 may control a flow of data from the FPGA 301 and/or the GPU 303 to certain output ports of the I/O system 308, such as to ethernet or optical ports, which may connect to a substation or other external system controlling the utility grid 1000.

The FPGA 301 may be configured to manage data before sending data (e.g., partially processed data) to the GPU 303 and/or the shared memory 304. For example, the FPGA 301 may conglomerate SPI signals from the SPI to analog cards 311-316 and/or partially processed data at the FPGA 301 into a serial stream for transmission to the GPU 303 and/or the shared memory 304. The FPGA 301 may manage analog signal processing for asynchronous clock timing of real-time, in-situ data before the data is sent to the GPU 303 and/or the shared memory 304.

The FPGA 301 may be configured to transmit data for processing or further processing to the shared memory 304 and thence be accessible directly to the GPU 303. For example, the FPGA 301 may be configured to upload a predefined set of data (e.g., all voltage, current, and/or phase determinations) to the shared memory 304 so that the GPU 303 may selectively access, from the shared memory 304, data needed for processing by the GPU (e.g., for artificial intelligence or machine learning processing). As another example, the FPGA 301 may identify, select, and transmit only data necessary for artificial intelligence (AI) or machine learning processing to the GPU 303 via the high speed data bus 305 and/or the shared memory 304. By selectively sending data to the GPU 303 and/or by selective access of the data by the GPU 303, the GEP 300 may optimize use of both the FPGA 301 and the GPU 303 to enable them to run at a significantly higher speed. For example, non-machine learning algorithm-related operations may remain internal to the FPGA 301, while the GPU 303 may solely handle AI processing. Because the FPGA 301 and the GPU 303 are on the same GEP main board 321, calculations by the FPGA 301 and also the GPU 303 occur together co-locally onsite at the utility grid (1000 of FIG. 1). For example, the GPU 303 may generate certain high value data, but may need additional processing (e.g., digital filtering) that the FPGA 301 may perform. The FPGA 301 may be configured to perform further operations on the generated high value data from the GPU 303, and send back its results to, for example, the GPU 303 (e.g., filtered data) via the high speed data bus 305 and/or the shared memory 304, or, as another example, directly to the I/O system 308.

Other means of transferring data to the GPU, such as disclosed in U.S. Pat. No. 10,552,935 issued Feb. 4, 2020 (incorporated by reference herein in its entirety), involves initiation of the transfer by a CPU through a shared memory using addresses or pointers in the main memory of the CPU. Such transfer may not be the most efficient, direct, or high speed method of transferring data, as it does not make use of FPGA programmable logic and new high speed data protocols.

The FPGA 301 may also be configured to transmit data to the cloud 3000 via the I/O system 308 for long term storage. Alternatively or in addition thereto, the GPU 303 may be configured to transmit data (e.g., logging data) determined by the FPGA 301 and provided to the shared memory 304 to the cloud 3000 via the I/O system 308 for long term storage.

The GPU 303 may be configured for more complex processing tasks, such as edge computing, machine learning, and/or artificial intelligence. For example, the GPU 303 may be configured to run anomaly detection algorithms, embedded edge algorithms for anomaly, fault detection, and condition monitoring. The GPU 303 may also access or receive external or additional data from remote systems and servers (e.g., from the cloud 3000) via the I/O system 308 and/or through the DAQ 302, depending on where such additional data is coming from. The GPU 303 may be configured to access remotely stored, long-term memory on the cloud 3000 via the I/O system 308, which may include previous calculations and configurations by the GPU 303 and/or the FPGA 301, time and date data, calendar data, weather data, and past data from prior systems, etc.

The GPU 303 may generate, from the accessed and/or received data, high value data, such as fault determinations, real time load changes, grid balancing, and other grid optimization calculations by executing one or more machine learning, AI, etc. algorithms on the data received from the FPGA 301. The GPU 303 may also be configured to implement machine learning to predict certain parameters, such as power consumption, based on past calculations and/or data. The GPU 303 may be configured to refine its algorithms and/or calculation methods based on past data, calculations, and feedback. The GPU 303 may be configured to determine illustrative representations and/or calculate images of its high value data, such as real time oscillography, that may be displayed on a display connected to the I/O system 308.

The GPU 303 may be configured to run one or more applications or apps, such as third-party apps, which may be remotely controlled by users (e.g., third-parties) via, for example, a web interface. The apps may control an operation of certain algorithms and/or an access of data stored in the shared memory 304. For example, a user operating a third-party app run on the GPU 303 may provide a command (e.g., a predict command) configured to initiate access of power consumption data for a certain time period from the shared memory 304 and initiate execution of a machine learning algorithm configured to predict power consumption for a certain future time period. The GPU 303 may be configured to send a signal, via the I/O system 308 to a substation to control power output or generation for the future time period according to the predicted power consumption. The GPU 303 may be configured to receive commands via the I/O system 308, or other signals prompting processing operations through the DAQ 302. In other examples, the apps may be configured to perform (e.g., periodically) certain data processing operations without prompting by a user.

Alternatively or in addition thereto, the GPU 303 may also be configured to perform pre-defined operations without prompting or initiating by a third-party app. For example, the GPU 303 may be configured to execute algorithms for fault detection and to send a signal to the substation to shut off or sectionalize the utility grid 1000 or reduce power generation upon determining a fault, anomaly, or emergency condition. Aspects disclosed herein are not limited to the specific types of determinations by the GPU 303 and/or whether they are initiated via third-party apps or predefined.

The GPU 303 may include an internal memory, which may be connected to the high speed data bus 305. In addition, the GPU 303 may be connected to a separate storage, such as a non-volatile memory express storage (NVMe storage) or NVRAM. With apps (e.g., third-party apps), and/or other data (e.g., data provided through the apps) being provided on the separate storage.

The GPU 303 may be connected to a serial communication device 322, such as RS232, configured to communicate system commands or queries (e.g., DNP commands, voltage, current harmonic distortion, harmonics). Software may also be upgraded through the serial communication device 322. The GPU 303 may also be connected to one or more sockets, for example an mPCIE socket 323 which may be used for radio modems, GPS, more memory, or other devices. Although not shown, the GPU 303 may also include an LEA DAC, like the FPGA 301, to quickly represent signal determinations on a smaller analog scale.

The GPU 303 may be configured to run software in Compute Unified Device Architecture (CUDA) for parallel computing, a software model standard by NVIDIA.

The GPU 303 may transmit high value data to one or more external systems 3000 via the I/O system 308. The GPU 303 may be connected to a switch 307 which may be connected to the I/O system 308. As previously described, the GPU 303 may later receive or access previously transmitted high value data by the GPU 303 and/or the FPGA 301 to learn trends, adapt to new data monitoring methods, etc. by implementing one or more machine learning algorithms. The GEP main board 321 may therefore perform machine learning algorithms and other predictive analyses onsite at the utility grid 1000, unlike current systems that run these algorithms at their servers. The GPU 303 may also be configured to transmit its high value data to the shared memory 304 for temporary (e.g., weeks long) storage in case issues occur (e.g., power outage) in transmission via the I/O system 308. Although one GPU 303 is illustrated, the GEP main board 321 may include a plurality of GPUs 303 for more processing power. Although a GPU 303 is described herein, other processors capable of executing machine learning technology or artificial intelligence may be used.

The high speed direct memory bus 305 may be configured to transfer data between the logic cells of the FPGA 301 and the internal memory of the GPU 303 and/or additional high speed data buses. For example, the shared memory 304 may connect to the logic cells of the FPGA 301 via the high speed data bus and be connected directly to the internal memory of the GPU 303. The shared memory 304 may be in addition to or an alternative to the high speed direct memory buses 305 directly connecting the FPGA 301 to the internal memory of the GPU 303.

The shared memory 304 may be configured for medium or long-term storage (e.g., weeks or more) of data, such as logging data. As an example, the FPGA 301 may periodically (e.g., every two minutes) transmit logging data to the shared memory 304. The shared memory 304 may retain data for, example, one or more weeks. Data stored in the shared memory 304 may be transmitted to the cloud 3000 for long term storage via the I/O system 308 (via the FPGA 301 and/or the GPU 303). The GPU 303 may be configured to access only the data it needs from the shared memory 304. For example, apps running on the GPU 303 and/or users interfacing with the apps via a web interface may determine what data to access from the shared memory 304.

The shared memory 304 may include, for example at least 128 GB of storage and may be High Bandwidth Memory (HBM) compliant with the HBM3 standard. For example, the shared memory 304 may include a Micron HBM3 or HBM3E memory cube or an SK Hynix HBM3 memory. In another example, the shared memory 304 may include a level 1, level 2, level 3, and/or level 4 cache (L1, L2, L3, and/or L4 cache) based on speed and/or memory needs or parameters.

The shared memory 304 may include bandwidth of greater than 1.2 TB/s, at least 1024 Input/Output (I/O) pins, with a pin speed of more than 9.2 Gbps. The shared memory 304 may be configured for at least 5.2 Gbit/s I/O speeds or 6.4 GBps/pin, bandwidth of at least 665 GB/s per package (e.g., 819 GB/s), at a data transfer rate of 6.4 Gbit/s. As another example, the shared memory 304 may include a memory of 16 GB and/or 24 GB aligned with 8-Hi and 12-Hi stacks respectively that consist of 8 or 12 16 Gb memory Dynamic Random Access Memory (DRAM).

The I/O system 308 may transfer data from the GPU 303 to an external or remote system 3000 such as the cloud, and may also transfer data to other onsite systems, such as a substation or system controlling the utility grid (1000 of FIG. 1). The I/O system 308 may be configured for high bandwidth to facilitate transmission of the high value, processed data and determinations of the GPU 303. The I/O system 308 may be accessible at an external side of the front panel 320. The I/O system 308 may include one or more low energy analog (LEA) ports 324, one or more serial communication devices or ports 325 (e.g., RS232), one or more USB ports 326 (e.g., USB A or C), buffered general-purpose input/output GPIO relays (327), one or more ethernet ports 328, and one or more optical ports 329 (e.g., for fiber optic communication cables).

The one or more LEA ports may be configured for transmission of signal representations from the LEA DAC of the FPGA 301. If the GPU 303 also has an LEA DAC, the GPU 303 may also be connected to the one or more LEA ports 324. The one or more serial communication devices 325 may be connected to the FPGA 301.

At least some of the one or more USB ports 326 may be connected to the FPGA 301. One or more external devices or detection systems 330, such as a global positioning system (GPS), may be connected to one or more of the USB ports 326. The FPGA 301 may receive data from these external devices 330 to assist in processing and/or making calculations using the data received from the DAQ 302.

The buffered GPIO 327 may be connected to the FPGA 301 and one or more local external devices such as LEDs or switches (e.g., connected to the substation) to quickly output determinations by the FPGA 301. For example, the FPGA 301 may determine anomalies in voltage or current and output signals via the GPIO 327 indicative of its determinations (e.g., a signal for an LED to turn red upon determination of an anomaly). Some of the external devices connected to the buffered GPIO 327 may be programmable, such as by a third-party. For example, a third-party may configure certain switches or relays to close or certain LEDs to change color upon certain determinations (anomalies, high voltage readings, etc.) by the FPGA 301. In some examples, the GPU 303 may be connected to a buffered GPIO, and the external devices may be programmed to be responsive to certain determinations (e.g., faults or power consumption predictions) by the GPU 303.

The one or more ethernet ports 328 may be connected to the FPGA 301 and/or the GPU 303, directly and/or via a switch 307. The FPGA 301 and/or the GPU 303 may open and/or close the switch 307 to control data transmission to the ethernet ports 328. The one or more ethernet ports 328 may be used to transmit data from the GPU 303 to the cloud 1000 so that the data is accessible from remote locations (e.g., via web interface). The one or more ethernet ports 328 may be configured with high transceiver bandwidth sufficient to transmit the high value data from the GPU 303. For example, the one or more ethernet ports 328 may be configured to support or implement General Packet Radio Service (GPRS) Tunneling Protocol (GTP). In addition, the one or more ethernet ports 328 may be used to transmit data to other local or onsite devices, such as a substation or power station. Having two (2) ethernet ports in a dual configuration may be advantageous so that one can be dedicated to outgoing transmission and one to incoming.

Similarly, the one or more optical ports 329 may be connected to the FPGA 301 and/or the GPU 303, directly and/or via a switch 307. The FPGA 301 and/or the GPU 303 may open and/or close the switch 307 to control data transmission to the optical ports 329. The one or more optical ports 329 may be used to transmit data from the GPU 303 to the cloud 3000 so that the data is accessible from remote locations (e.g., via a web interface). The one or more optical ports 329 may be configured with high transceiver bandwidth sufficient to transmit the high value data from the GPU 303. In addition, the one or more optical ports 329 may be used to transmit data to other local or onsite devices, such as a substation or power station.

The number and type of ports of the I/O system 308 is not limited. For example, the I/O system 308 may include one or more HDMI ports, one or more relays, a door switch, and one or more thermistors, etc. In another application one or more HDMI ports of the I/O system 308 may be connected to an external monitor, and the data from the GPU 303 may be displayed on the monitor via a graphical user interface (GUI). As an example, the monitor may have one or more input devices (e.g., touch screen, keyboard) to allow interaction with the displayed data.

By having an FPGA 301 and GPU 303, the GEP 300 may process large tranches of data and perform low-level computations, as well as run complex algorithms and programs on-site at the grid edge. For example, the GEP 300 may be configured to perform all of DSP, filtering, and compensation of environmental variables such as temperature, and calculations of primary attributes of transmission such as voltage, current, power factor, phase angle, or any of the DNP points that are communicated over present day utility SCADA networks. The GEP 300 may be configured to perform all of these tasks with at least 16-bit resolution for high DSP fidelity. The GEP 300 may implement fast GHz computer processing units (CPUs) for enhanced resolution, processing through a number of channels, and fast sampling. The GEP 300 may therefore both process data associated with DAQ conversion in computing DNP points synchronously to enable timing conditions for a smart-grid and process autonomously such information with machine and statistical learning algorithms.

The GEP 300 may be configured to communicate, for example via I/O system 308, at high internet bandwidth rates rapidly with external systems and networks to relay said information of power transmission for smart-grid, distributed machine learning, and artificial intelligence (AI) applications, including with systems operators, central control rooms of the utility, and cloud and data based asset managing programs. The GEP 300 may be a situationally aware system at a localized edge of a utility grid 1000, enhancing safety to personnel and equipment for major transient and fault events, such as environmental or lightning strikes.

Aspects disclosed herein may provide GEP hardware that affords asynchronous to synchronous DAQ processing with algorithms, subroutine modules, and functions that may be placed on the ARM processor in the FPGA. The FPGA may subsequently communicate any necessary data to the GPU solely for AI processing. This approach may capitalize on the strengths of both platforms and ensure that all algorithm-related operations remain internal to the FPGA, enabling them to run at significantly higher speed. Utilizing modern FPGAs may be advantageous and beneficial by having an integrated hard ARM and/or soft-core processors and an FPGA with significant number of logic cells, memory resources, and clock timing bandwidths that can manage peripheral devices, fast I/O analog, digital, and mixed signals, through SPI configurations and other modern, fast, DAQ protocols and methods.

The DAQ 302 may further include one or more voltage regulators 331 connected to the PCIE connector 310. The one or more voltage regulators 317 may regulate the various voltages (1.2, 1.8, 3.3, 5 volts, 12 volts, etc.) required for various chips and boards used in the main board 321. Said voltage regulators may be connected to voltage rails supplying the DAQ cards and boards, as well as Lithium-Ion battery charging pack as well as external batteries and DC supplies.

Although a utility grid (FIG. 1, 1000) is described as an example, aspects disclosed herein are not limited to monitoring utility grids. For example, the GEP board 321 may be used in other power, current, or voltage monitoring systems, other utility systems (e.g., water and/or plumbing systems), or even in other systems having other types of sensors, used in and/or based on a distributed grid or fleet such as environmental monitoring systems, automotive systems, and medical device systems, etc. The described embodiments can provide a novel and advanced solution for real-time monitoring and management of utility electrical grids and/or other grids. The integration of technologies, real-time processing capabilities, and machine learning algorithms represents a significant advancement over existing grid monitoring.

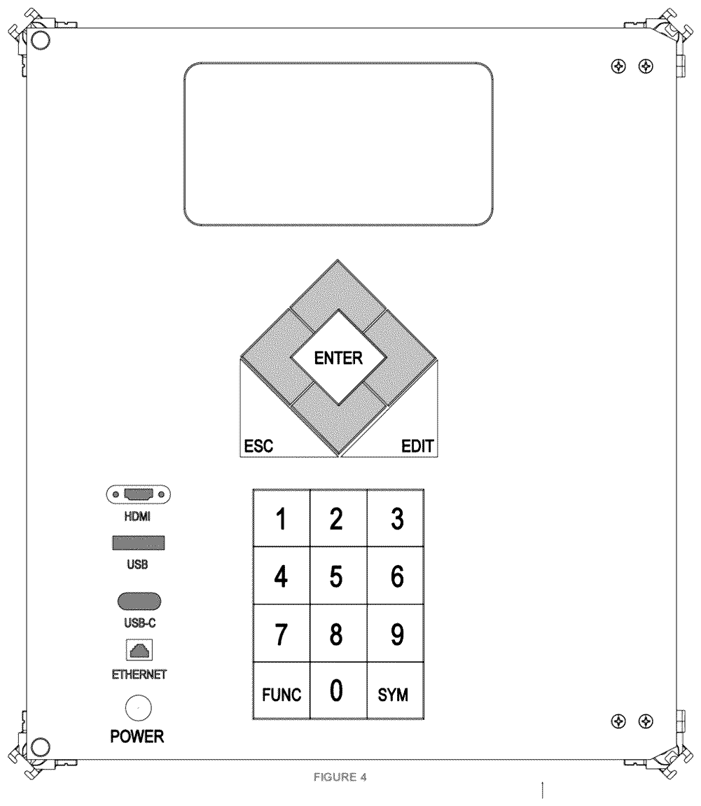

FIG. 4 shows the front panel display referred to in the schematic of FIG. 3. It shows a conceptual mock-up of the external ports, such as RS232, HDMI, USB, and GPIO relays with a keypad and display.

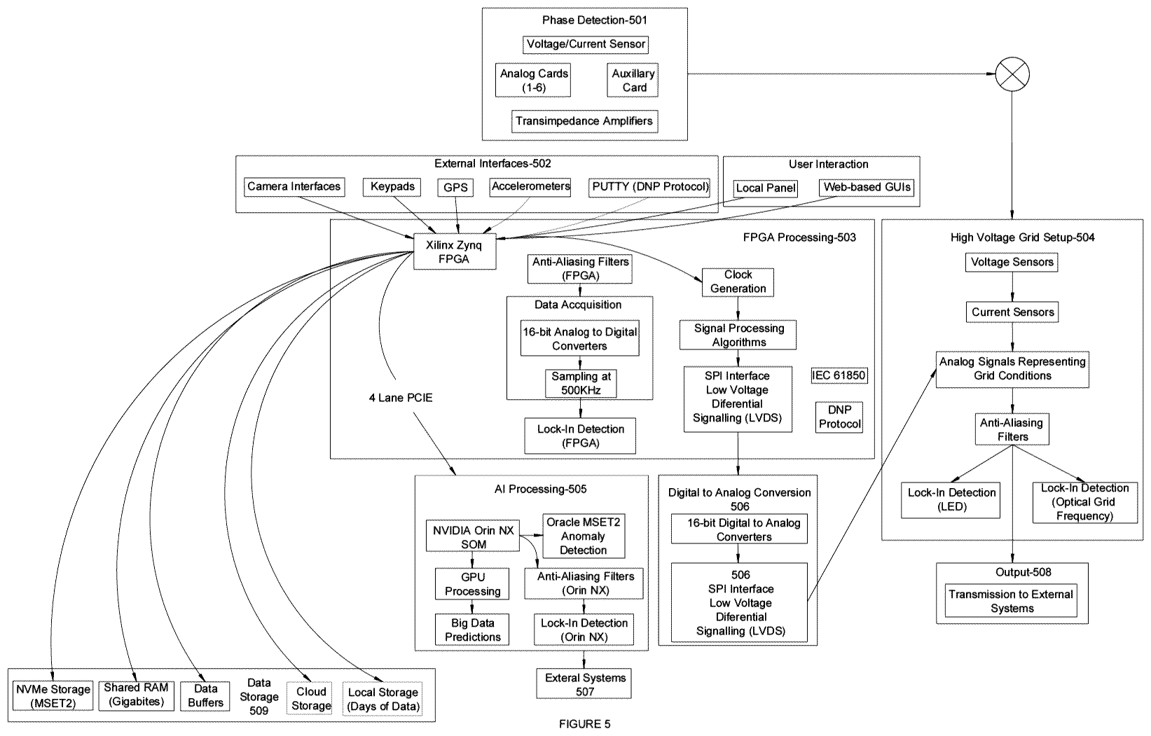

FIG. 5 shows aspects pertaining herein to the software and or firmware systems 500 of the GEP hardware (300 of FIG. 3). The main phase detection block 501 translates signals from sensors to a method of DAQ signals that have been detected and modulated by the voltage and current sensors, for example, on the power distribution or utility grid (1000 of FIG. 1). These signals are routed to the analog cards (referring to 311-316, and auxiliary card 317 of FIG. 3) having analog to digital converters which are synchronously sampled at the 16-bit level. The analog cards may have, as described herein but not limited to, transimpedance amplifiers, opto-electronics circuits, photodiodes, and also local memory for sensor setting parameters, outputting modulated DAQ signals which may be subject to hardware filtering or software filtering (e.g. low-pass, high pass etc.) for anti-aliasing and other DSP functions. SPI is the main physical serial layer and protocol, with LVDS (low voltage differential signaling) to aid in noise immunity at the physical layer. JESD204 may be implemented to further enhance bandwidth and reduce net congestion. This framework facilitates several data acquisition channels into a low net serial stream of high speed and bandwidth.

In algorithm block or FPGA processing 503, external interfaces are shown as ways of getting information in and out of the hardware/software main board system. In addition, camera interfaces may be included with 2 and 4 lane camera serial interfaces (CSI), as well as USB. Cameras may be used for vegetation monitoring as well as environmental and system monitoring. Keypads include simple front panel buttons for quick setup, to optional keyboard interfaces with a software keypad that may be coded on a touchscreen for future use. The GPS hardware allows remote query of system location and other GPS features may be available depending on the GPS chipset used for timing and synchronization. Accelerometers may be mounted on the board to gauge shock and tilt parameters of the system as well as an indication of wind speed which may be deduced from accelerometer data as well. An internet/ethernet PUTTY interface for DNP protocol queries and configuration of software and firmware may be included with user Interaction being local or remote and affecting the system in various ways. The local panel may include user buttons and a touch screen LCD. Mouse and keyboard may be attached for an easier method of control. Web-based GUI's (Graphical User Interfaces) may be based on web browsers given certain security clearances and may also be a means of remote control and monitoring. Displays such as voltage and current waveforms may be displayed in an integral fashion with the GUI functions. The GUI may also provide a means of software and firmware updates, as well as data download capability for historical power grid condition queries.

The main algorithm block 503 refers to software/firmware for the FPGA (Field Programmable Gate Array) and main hardware sampling system being comprised of a large number or block or blocks of internal logic cells, and may or may not include CPU's for running the main programs. For example, the main algorithm block 503 may include an Xilinx Zynq Ultra-scale MPSoC and associated software/firmware suite, is one potential preferred embodiment allowing extreme flexibility for upgrade, modification, and functionality. It may have anti-aliasing and digital filtering on the fly capability. Aside from simple hardware pre-anti-aliasing filtering, software digital filtering may be of high-pass, low-pass, band-pass, and band-reject variety. This capability allows unknown third-party sensors the ability to integrate and adjust filtering if needed. The AC and DC signal data may be separated, for instance digitally, for separate use in the algorithms. The DAQ ADC digitize the data at the 16-bit level (65536 steps over the ADC range) which allows precise grid mirroring at the low voltage analog and/or LEA levels. The sample rate allows for detection of up to the 2500th harmonic of 60 Hz and 50 Hz of AC typical power grid frequencies. The signals on the analog cards are sampled synchronously with the help of the FPGA and may include lock-in detection. Clock generation is typically counter based, and may come directly from the FPGA, or also output from the GPU if desired. The programmable nature of the system allows this flexibility in signal processing algorithms with software/firmware pointers and handles used to manage the high speed data for digital filtering, in order to process the signals representing fidelity of grid status and deduce monitoring conditions (e.g. voltage and current).

The SPI interface is a simple clocking scheme of data typically used with a 20 MHz maximum clock rate. SPI interface protocols can suffer due to impedance matching concerns, crosstalk, and physical limitations of the circuit boards. Quad-SPI (QSPI) is available and may be utilized in order to split the bandwidth in some cases to handle more data in the same given time. LVDS (Low Voltage Differential Signaling) is a physical layer circuit setup where transistor-transistor logic TTL (0-5V say) signals are split into current loops on two traces. This reduces noise which is rejected due to the noise on both traces cancelling each other. Here impedance mismatches are much reduced, and speeds are increased to 100's of MHz. This physical voltage and current translation can be used to enhance software/firmware protocols.

The DNP Protocol (Distributed Network Protocol) is key to voltage grid communications. Special endpoint numbers are addresses or pointers to specific data such as voltage, harmonic noise which are computed and stored in the 503 block. Typically this protocol uses PUTTY as above, RS232, or other serial data pipe methods. In addition IEC 61850 is an international standard defining communication protocols for intelligent electronic devices at electrical substations and may be utilized in the software/firmware to allow proper modern communication to various parties handling power grid data.

In some examples, initial data processing may include identifying, via the FPGA 301, data and/or determined FPGA values to transmit. For example, initial data processing at main phase detection block 501 may include identifying data and/or determined FPGA values that require further processing via artificial intelligence and/or machine learning algorithms. As another example, initial data processing at main phase detection block 501 may include identifying data and/or determined FPGA values that require fast and/or immediate response (e.g., data that might be indicative a fault condition, a rapid change in current, voltage, or phase angle, an anomaly in current, voltage, phase, a first FPGA value that exceeds a threshold, etc.). The identified data may include the at least one FPGA value determined by the FPGA 301 and/or at least some of the data acquired during data acquisition. Identified input data may include external sensors 502 data, and may involve initiation by user interaction 503 or input (FIG. 4). The primary inputs for an electrical or high voltage grid setup 504 in the preferred embodiment are the voltage and current sensors from which data is captured by high speed DAQ (302 of FIG. 3).

High speed transmitting may include transmitting data from the FPGA 301 to the GPU 303, either directly or via a shared memory 304. The transmitted data may include the determined FPGA values and/or at least some of the data acquired during data acquisition. When the FPGA 301 has identified and/or selected data, the transmitted data may include the identified data (e.g., only the identified data). High speed transmitting may include transmitting data directly from the logic cells of the FPGA 301 to the internal memory of the GPU 303 via the high speed direct memory data bus 305. Alternatively or in addition thereto, high speed transmitting may include transmitting data from the logic cells of the FPGA 301 to the shared memory 304, and accessing, by the GPU 303, the data in the shared memory 304 transmitted by the FPGA 301. High speed transmitting 503 may include receiving, at the GPU 303, a command or signal to access certain data in the shared memory 304.

As an example, the FPGA (301 of FIG. 3) may identify data required for further processing by the GPU 303 (e.g., data that needs machine learning or AI processing) during initial data processing and/or high speed transmitting may include transmitting only the identified data to the GPU via the high speed direct memory bus 305. As another example, the FPGA 301 may not necessarily identify specific data that needs AI process during initial data processing, and high speed transmitting may include periodically sending a predefined set of lower speed data (e.g., all logging data, all determined FPGA values, predefined FPGA values such as current, phase, current vs. time, etc.) to the shared memory (304 of FIG. 3). High speed transmitting from may also include accessing, by the GPU, certain data in the shared memory 304 based on an algorithm to be performed, via a user command, on predefined data in third party apps, etc. In yet another example, the FPGA may identify data for faster processing (e.g., data indicative of a fault or emergency situation) during initial processing, and in such a situation, high speed transmitting from may include transmitting the identified data directly to the GPU via the high speed direct memory bus and/or transmitting the identified data directly to the output system 508 (e.g., LEA Ports 324, GPIO 327 of FIG. 3) in order to output the identified data and/or an alert or other signal indicative of the identified data (e.g., red LED light, sound, display, etc.) during outputting determinations, bypassing machine learning.

Machine learning at AI Processing 505 may include executing at least one machine learning algorithm using at least some of the data accessed by the GPU, whether through the high speed direct memory bus (305, of FIG. 3) and/or via the shared memory. Machine learning may therefore occur on the same main board as initial data processing so that all processing and computing is performed onsite at the utility grid 1000. Although a GPU is described, alternatively, other processors capable of machine learning may be used. The at least one machine learning algorithm may include a multivariate state estimation technique or MSET algorithm, Oracle Cloud Infrastructure (OCI) algorithms, predictive algorithms, etc. The at least one machine learning algorithm may be provided by an application (e.g., third-party app) that is run by the GPU. For example machine learning may include receiving at least one machine learning algorithm via a web interface and/or application to execute. In addition, machine learning may include receiving a command that initiates running and/or executing the at least one machine learning algorithm, and algorithms and programs locally in the GEP on the edge in a distributed and federated cloud computing fashion with high speed transceiver bandwidth. The GEP may be part of a distributed next generation cloud networked platform or system. Such edge computing (c.f. OCI) running, for example, an MSET algorithm may be used to create high value data communication to enterprise systems for management and control of utility grid assets.

Software and firmware for machine learning may include determining at least one GPU value based on the execution of the at least one machine learning algorithm. The GPU value may be indicative of a fault condition of the utility or power system or component, such as the utility grid 1000. In some examples, determining the at least one GPU value may include comparing at least one intermediate value generated from the execution of the at least one machine learning algorithm and comparing the at least one intermediate value to a threshold. After onsite edge computing of FIG. 5 as performed by main board 321 of FIG. 3, the FPGA and/or GPU values may be output to an external service 507, a remote physical location such as a substation, the cloud (1000 of FIG. 1) etc.

The D/A conversion block 506 acts upon digital data derived from FPGA processing block 503. This may supply data points and LEA signals for the high voltage grid setup necessary for output in software/firmware block 508. For high voltage utility grids, a synchronous signal setup 506 for the voltage and current sensors is provided. The voltage and current sensors are near the power line carrying the high voltage and current, which are on the utility grid yet the GEP is agnostic to the type of sensors and acquisition hardware. The main purpose of software and/or firmware in the 506 block is generation of LEA signals representing grid conditions on the power grid and supplying oscillography. There is a ratio number volts/volt where high voltage is represented by low voltage of the main system. Anomalies and disturbances are captured and sent out these analog interfaces to other devices with minimal delay. Anti-aliasing filters as before, digitally sampling data requires at least a simple anti-alias filter in hardware to prevent reflections of signals after sampling. This filter bandwidth is typically set to twice the highest frequency of interest, and is based on Nyquist criterion. Lock-in Detection as it pertains to the LED modulation would be a method of modulating the fiber LED intensity to remove the desired data from noise for optical sensors. This as stated before, may be introduced during software and firmware initial construction, or any point thereafter. Lock-in detection as it pertains to the high voltage power grid modulation would be a method of demodulating the pockels effect in the data. Knowing the approximate power grid frequency, data riding in synchronization phase to the wavelength may be enhanced and pulled from noise. Here this could be the primary lock-in method, while LED modulation could be a further secondary lock-in procedure.

Software and Firmware for output transmission to external systems 507 may include several output mechanisms may exist to transfer data. Some are to be the LEA, others may be FFT (Fast Fourier Transform) data to the GPU. Serial data communication from simple local RS232 to web-based serial protocols may be used depending on desired functionality and third party permissions.

External apps and systems comprise of third party users software and/or firmware may be utilized. The software and/or firmware will be handled and data access with security being limited based on credentials. Development boards may be created for end users based on this entire platform, and voltage grid monitoring is not a requirement for use of this system. Digital to Analog converters (DACs) are used to translate digital values to analog voltage levels. In this system DACs are used to recreate the grid patterns (c.f. voltage and current) as in the LEA's (Low Energy Analogs), and for example, intensity changes of opto-electronic signals related to optical sensors, or electrical signals in other types of non-optical sensors. The DACs need to be sampled such that proper representation of signals is carried out which may be done through LVDS in a simple physical layer translation from single ended to differential signals reducing noise and allowing much faster communications, while relaxing the circuit board layout requirements.

Several methods of data storage 509 comprise this system. NVMe (Non-Volatile Memory Express) and NVRAM (non-volatile random access memory) are very fast storage interfaces to be used in software and/or firmware methods. These storage methods can hold computer memory so the data is preserved when the power goes down or is unavailable to any integrated circuits or ships on the main board (e.g. the SoC or SOM). Typically the memory is socketed on a M.2 form factor. This allows easier swapping of newer, larger memory, or just data transfer capability. Large quantities of shared RAM (Random Access Memory), for example gigabytes, may be shared between the FPGA and the GPU. This allows each platform access to the same data for different processes required. Data buffers are required to handle the various speed limitations of each system, for example, FIFO buffers (First In First Out) are required to handle burst data. The GEP may advantageously use the Linux operating system, which for example, may handle data asynchronously as it is able, despite actual sampled data being synchronous at a constant rate. FIFO buffers would not be necessary if all systems could handle all of the data in real time, however, that may not be possible at all times in Linux. Additional storage may be provided using data storage local drives such as, for example, Solid Stage Drive, or USB drives.

Software and firmware aspects disclosed herein may implement multiple channels, synchronous timing, and run machine learning firmware. Aspects disclosed herein are not limited to types of sensors and may implement other types of sensors (e.g. voltage, temperature, vibration) requiring high speed data sampling and digital signal processing. Aspects disclosed herein may use Distributed Network Protocol (DNP) for high-level data, faults, and noise parameters. DNP is a set of communications protocols used between components in process automation systems including harmonic distortions, voltages, and currents, among other data. Aspects disclosed herein may implement software running in the “C” language, “Python”, and/or “VHDL” for use in the FPGA. Aspects disclosed herein may implement software run in “CUDA” Compute Unified Device Architecture, per NVIDIA standards, for use in parallel computing of a graphical processing unit or GPU's sensor input data. Aspects disclosed herein may run Linux to handle much of the data and system communications. Aspects disclosed herein may incorporate edge computing where major decisions on large amounts of data are run local, and high value lower bandwidth data are reported to cloud based fleet systems. Software and firmware aspects disclosed herein may implement the MSET anomaly detection algorithm of OCI on large streaming, buffered, or stored data sets. VHDL may clock data acquisition cards consisting of analog to digital converters (A/D), and digital to analog (D/A) converters in a synchronous fashion in lock step with each other. Software and/or firmware aspects and attributes disclosed herein may reduce data acquisition and processing times by managing timing and clocking of input analog, mixed, and digital, asynchronous to synchronous DAQ processing, by, for example, using SPI interface or JESD204 type protocol on IP cores.

The GEP software and/or firmware may include three critical function units: analog to digital (A/D) conversion DAQ cards for input of signals from sensors, a programmable logic or floating point gate array (FPGA) System on Chip (SOC) to synchronously input the real-time, in-situ signal data, and possibly combined with a central processing unit (CPU) to construct buffered data which is subjected to computations and calculations, and a parallel processing Graphics Purpose Unit (GPU) that is specifically adapted to run higher level machine and statistical learning algorithms.

Software and firmware aspects disclosed herein may provide and/or control automated and autonomous functionality of modern switchgear in utility and power distribution grids, networks, and Distributed Energy Resources (DERs) for fast execution of circuit breakers and reclosers, thereby activating sectionalizers to isolate faulty sections of a grid circuit enabling real-time, in-situ load management to restore power supply and maintain power factor.

While present solutions to grid systems response can provide precision and accuracy, they lack the speed, sophistication, safety mechanisms, and real-time, in-situ fast timescales required of fault detection schemes needed to avert catastrophic failure. In these systems, high voltage may not be turned off on a fault, and fluctuations due to environmental, climatic or meteorological conditions, or lightning strikes, can cause damage, fires, and devastation. Incorporating a fast machine learning telemetry platform enhances reliability of utility grid management software while reducing required or forced software changes. Moreover, machine learning and artificial intelligence based on such software may quickly and optimally adapt to such changing conditions, priorities, and data requirements. Aspects disclosed herein may provide software and firmware responsive to such adverse electrical grid conditions and with fast, accurate telemetry, and more than simple grid data reporting as described in PCT/US23/75135, U.S. application Ser. No. 18/474,850. Such fast telemetry is also a pre-requisite for precise fault, transient, and harmonic condition monitoring. Such actionable monitoring may use edge computing to quickly prevent disaster based on thresholds of severity, and then report to main systems and servers the details of the fault and mitigation to be performed on the utility grid.

This can be achieved using a high speed data acquisition processing and machine learning telemetry platform that includes advanced computing. The platform can operate autonomously at the edge and/or among remote nodes of a utility grid. Such a system or Grid Edge Platform (GEP) would provide hardware and software architecture outlines that enable edge computing so that incorporating major decisions on large amounts of high speed data are run local along with high value lower bandwidth data which are reported to cloud based data asset and fleet systems. Combined with high speed sensors, (such as optical sensors measuring high voltage and current), latency may be significantly reduced and/or effectively eliminated for the purposes of fault detection. Such a GEP would offer significant commercial applications, particularly in enhancing the accuracy of power consumption predictions. The integration of artificial intelligence with such a platform opens up numerous possibilities for cost savings and innovative data uses in the utility sector. Such a system may communicate at high speeds with enterprise networks and/or servers. This can enable efficient data transmission and remote management with transceiver communication to cloud based network and server assets.

Given modern microprocessor and semiconductor advancements, it is possible to now consider System on Chip (SoC) and System on Module (SOM) combinations or integrations of a programmable logic Floating Point Gate Array (FPGA) and one or more graphics processing units (GPUs). A platform or board can utilize SoCs and SOMs and integrate several components, such as data acquisition systems, processing units, anomaly and fault detection firmware, communication interfaces, and/or for grid monitoring. Such aspects disclosed herein provide for novel main microprocessor board that obviates a need for a backplane with all cards, SoCs, and SOMs, plugging directly into the main board, including critical Data Acquisition (DAQ) and Analog to Digital circuitry (ADC) that facilitate the capacity to manage this functionality using the FPGA.

It is therefore possible to have a utility or electrical grid edge Digital Signal Processing (DSP), computing, and machine learning capable processing platform of real-time, in-situ signals data and oscillography, which is not available in current or traditional solutions. The grid edge use of a parallel processing Graphics Processing Unit (GPU) as a hardware adaptation that has this functionality in a deployed embedded platform, and incorporating it into embedded firmware for data and condition monitoring is beneficial and advantageous. The GEP platform would be capable of running embedded, edge computing, and machine learning algorithms allowing for rapid adaptation to new data monitoring methods. Given that current technology is moving toward utilizing parallel GPU computing, the GEP as an embedded, edge computing platform can support machine learning and artificial intelligence in contrast to legacy technology.

FPGAs can be highly flexible for various applications, and GPUs can handle tasks that require simultaneous processing of parallel tasks, particularly for hardware acceleration, artificial intelligence, and scientific computing. The combination is faster than traditional central processing units, e.g. CPUs, for certain tasks, and other processors can be further incorporated and integrated, such as CPUs, microcontrollers, microprocessors, and/or other digital signal processing (DSP) units. Aspects disclosed herein, however, can enable faster data communication transfer rates (than DAQ SPI) between the FPGA and other processors, which is crucial for high-performance computing tasks, real-time processing, or high speed data acquisition systems. By transferring data quickly, the overall system performance is enhanced as data from an FPGA may be transmitted via a high speed direct memory transmission bus to a GPU.

The machine learning telemetry platform may include a high speed data and memory link/bus between an FPGA with configured logic cells and a combined, included, or embedded ARM reduced instruction set processor (in the example of a Zync Ultrascale SoC), and a GPU system SOM. The aforementioned system may be configured to address the issue of latency, as a programmable logic FPGA is utilized to satisfy the fast response times needed, thereby supporting the required GOOSE timescales of 2-4 milliseconds. Modern FPGAs have a large number of programmable logic cells that are configurable upon hardware initialization using a JTAG interface. Such an architecture can solve the challenging timing and clocking of input analog, mixed, and digital, asynchronous to synchronous DAQ processing, for example as in the Serial Protocol Interface (SPI). Aspects disclosed herein may provide a high speed transfer link from, for example, an example including a Zync Ultrascale containing programmable logic FPGA functionality with an ARM conventional processor (c.f. CPU), DAQ cards, memory, and an NVIDIA Orin GPU. The ARM CPU processor may not be suited for statistical, machine learning, or AI applications, while the GPU may seamlessly integrate with certain software architectures, such as an Nvidia CUDA software architecture. Aspects disclosed herein may integrate high speed link/bus between an FPGA (with ARM) and a GPU SOM. Aspects disclosed herein may implement fast SPI to DAQ modules and concurrently, the FPGA can be connected to the GPU via a high speed link/bus, enabling efficient data transfer. The bus speed may be comparable to or greater than enhanced direct memory access (EDMA) and/or direct memory access (DMAC) methods.

Aspects disclosed herein may provide hardware architecture high speed links and buses between the FPGA-CPU and the GPU SOM, and an implementation capable of supporting fast SPI data from the analog to digital DAQ cards or converters. The FPGA (e.g., Zync Ultrascale) to CPU (ARM) processor may also have a bus speed comparable to or greater than Enhanced Direct Memory Access (EDMA) and Direct Memory Access (DMAC) methods.

The system may place algorithms on an ARM processor of the FPGA-ARM combination, communicating necessary data to the GPU for AI processing. This approach may optimize the use of both platforms, ensuring high speed operation and data integrity. The FGPA on the main board may be configured to handle and manage fast SPI data from the analog signal processing DAQ Modules for asynchronous clock timing of real-time, in-situ data. This data may require a high speed memory bus link transferring streaming data from the FPGA (e.g., Zync Ultrascale FPGA) with ARM CPU to the GPU card's memories. The system may have placed algorithms, programs, firmware on the ARM processor within the FPGA, communicating necessary data to the GPU for AI processing. Aspects disclosed herein may optimize the use of both platforms, ensuring high speed operation and data integrity.

Aspects disclosed herein may provide techniques for data acquisition and processing. Aspects disclosed herein may implement Very High Speed Integrated Hardware Description Language (VHDL) to clock data acquisition cards in a synchronous manner. The cards may include ADC converters, and/or digital to analog converters (DAC). Acquired data may be transferred at high speed from the FPGA to the GPU for processing and/or analysis. Aspects disclosed herein may implement high speed DSP and sampling with an NVIDIA GPU. Aspects disclosed herein may use Nyquist sampling for the 70th harmonic equal to 60 Hz×70^{th} Harmonic×2×m KSamples/sec, equal to 60*70*2*8, equal to 67.2 KS/sec, with a factor of m=2 for margin, equal to 134.4 KS/sec. Aspects disclosed herein may use sampling bandwidths for vibration times scales that are greater than factor of 10 than aforementioned. Aspects disclosed herein may use sampling bandwidths up to the 2500th harmonic. Aspects disclosed herein may use a 16 bit N*GHz processor, where N is max sampling.

Aspects disclosed herein may provide a Grid Edge Platform (GEP), which as a computing and data acquisition platform is configured to perform independent and autonomous machine learning at the edge and remote nodes of a utility or power distribution grid. One or more GEPs may be provided onsite at the edge or remote nodes of a utility or power distribution grid and receive data from sensors also onsite at the utility or power distribution grid. The one or more GEPs may therefore perform onsite data processing, at the grid edge, without needing to transmit data offsite to a remote processing system. The methods and architecture described herein can support high speed transceiver bandwidth to external cloud, enterprise, and Distributed Access Control System (DACS) servers.

The above discussion is meant to be illustrative of the principles and various embodiments of the present invention as pertaining to software and/or firmware used in 500 and the main board (300 and 321 of FIG. 3). Numerous variations and modifications will become apparent to those skilled in the art once the above disclosure is fully appreciated. It is intended that the following claims be interpreted to embrace all such variations and modifications.

A processor board is configured to monitor a utility grid. A data acquisition system may be configured to acquire data from one or more sensors of the utility grid. A field-programmable gate array (FPGA) may be configured to manage the acquired data and to execute at least one algorithm using the acquired data. A graphics processing unit (GPU) may be configured to execute at least one machine learning algorithm on at least one of the acquired data or data processed by the FPGA. The GPU may be configured to output data to a remote system via an input/output system.

The GPU may be configured to predict a future condition of the utility grid. The FPGA may be configured to detect an instant fault condition of the utility grid. The FPGA may be configured to output data via the input/output system. The acquired data may include light data, such as modulated light intensity. The FPGA may be configured to determine at least one of voltage, current, or optical phase based on the modulated light intensity. At least one of the FPGA or the GPU may be configured to determine a fault condition of the utility grid based on the determined voltage, current, or optical phase. The FPGA and/or the GPU may be configured to determine a fault condition of the utility grid in less than 2 milliseconds after the data is acquired. The GPU may be configured to determine at least one of a current fault condition of the utility grid or a predicted fault condition of the utility grid by executing the at least one machine learning algorithm.

A high speed data bus may be configured to transmit data from logic cells of the FPGA to a memory of the GPU. Alternatively or in addition thereto, a shared memory may be connected to the logic cells of the FPGA and a memory of the GPU. The GPU may be configured to identify data in the shared memory that requires machine learning processing and access the identified data. Alternatively or in addition thereto, the FPGA may be configured to identify data required for processing by the at least one machine learning algorithm. The FPGA may be configured to send only the identified data to the GPU.

A utility grid monitoring device may include the processor board and the input/output system. The device may be configured to be installed at an edge of the utility grid. A utility grid monitoring system may include the utility grid monitoring device and the one or more sensors. The one or more sensors includes optical voltage sensors.

A grid edge monitoring device may be configured to monitor a utility grid. The grid edge monitoring device may include a housing and a processor board or Grid Edge Platform provided in the housing. The processor board may include a data acquisition system configured to acquire data from one or more sensors of the utility grid, a field-programmable gate array (FPGA) configured to manage the acquired data and to execute at least one algorithm using the acquired data, and a graphics processing unit (GPU) configured to execute at least one machine learning algorithm on at least one of the acquired data and/or data processed by the FPGA. The GPU may be configured to output data to a remote system via an input/output system.

The input/output system may be accessible from an external side of the housing. The housing may be configured to be installed at an edge of the utility grid. The processor board and/or device may include a plurality of analog card slots to receive data from a plurality of analog cards. The housing may be configured to be installed at a telephone pole.

A grid monitoring system may include one or more sensors and a grid monitoring device configured to monitor a utility grid. The grid monitoring device may include a housing and a processor board or a Grid Edge Platform provided in the housing. The processor board may include a data acquisition system configured to acquire data from one or more sensors of the utility grid, a field-programmable gate array (FPGA) configured to manage the acquired data and to execute at least one algorithm using the acquired data, and a graphics processing unit (GPU) configured to receive data from the FPGA and to execute at least one machine learning algorithm on the received data. The GPU may be configured to output data to a remote system via an input/output system. The one or more sensors includes one or more optical voltage sensors configured to detect a modulated light intensity. The FPGA may be configured, via an ARM processor, to determine at least one of an optical phase, current, or voltage based on detected modulated light intensity. The GPU may be configured to predict a condition of the utility grid based on the determined optical phase, current, or voltage. The utility grid monitoring device may be provided at an edge of the utility grid. The at least one sensor and the utility grid monitoring device are provided on a telephone pole.

A method of predicting a condition of a utility grid may include acquiring, via a data acquisition system, data detected at the utility grid; executing, via a field programmable gate array provided on the processor board, at least one algorithm using the acquired data; executing, via the GPU, at least one machine learning algorithm on at least one of (a) data from the field programmable gate array and/or (b) the acquired data; predicting, via the GPU, a condition of the utility grid based on the execution of the at least one machine learning algorithm; and outputting the prediction to a remote system.

The FPGA may be configured to manage the acquired data and at least partially process the acquired data. The method may include identifying data required for machine learning. The method may include transmitting the identified data to a shared memory between the FPGA and the GPU, and/or the GPU. The method may include periodically transmitting data from the FPGA to a shared memory between the FPGA and the GPU. The method may include identifying data in the shared memory required for machine learning. The method may include accessing, by the GPU, the identified data. Executing the at least one machine learning algorithm may include executing a multivariate state estimation technique (MSET) algorithm.

A method of monitoring a utility grid may include acquiring, via a data acquisition system, data detected at the utility grid; executing, via a field programmable gate array provided on the processor board, at least one algorithm using the acquired data; executing, via the GPU, at least one machine learning algorithm on at least one of (a) data from the field programmable gate array and/or (b) the acquired data; determining a condition of the utility grid based on the execution of the at least one machine learning algorithm by the GPU and/or the at least one algorithm by the FPGA; and controlling the utility grid based on the determination.

Determining the condition may include detecting a fault condition, and controlling the utility grid includes shutting down at least a section of the utility grid based on the detected fault detection. The fault condition may be transmitted to a substation that shuts down the section of the utility grid.

A method of monitoring a utility grid may include providing a machine learning algorithm to a grid monitoring system; receiving, from the grid monitoring system installed at a utility grid, a condition of the utility grid, the condition having been determined by the grid monitoring system executing at least one algorithm via a field programmable gate array and the provided machine learning algorithm via a graphics processing unit.

The method may include sending one or more commands to the grid monitoring system to control the utility grid. The received condition may include at least one of a detected fault of the utility grid or a prediction of a condition of the utility grid.

1. A Grid Edge Platform (GEP) configured to monitor a utility grid and perform onsite, independent and autonomous machine learning at the utility grid, comprising:
a data acquisition system (DAQ) configured to acquire data from one or more sensors of the utility grid;
a field-programmable gate array or a floating point gate array (FPGA) configured to manage the acquired data and to execute at least one algorithm using the acquired data;
a graphics processing unit (GPU) configured to execute at least one machine learning algorithm on at least one of the acquired data or data processed by the FPGA; and
an input/output (I/O) system through which the GPU outputs data to a remote system.

2. The GEP of claim 1, wherein the GPU is configured to predict a future condition of the utility grid and/or perform grid optimization calculations.

3. The GEP of claim 1, wherein at least one of the FPGA or the GPU is configured to detect an instant fault condition of the utility grid.

4. The GEP of claim 1, wherein the I/O system is configured to communicate with a system controlling power output of the utility grid, and the GPU is configured to determine a change in power output of the utility grid based on at least one of a fault detection, a predicted future condition, and/or a grid optimization calculation of the utility grid.

5. The GEP of claim 1, wherein the DAQ is configured for a sampling rate of at least 96 KHz and includes:
a plurality of connected data acquisition (DAQ) cards; and
a high-speed serial peripheral interface (SPI) for data acquisition, wherein the SPI operates in full duplex mode to allow data to be simultaneously sent and received.

6. The GEP of claim 5, wherein the FPGA is configured to manage data acquisition through the SPI, clock timing, and processing of real-time in-situ data acquired by the DAQ.

7. The GEP of claim 1, further comprising a plurality of radiating fins for heat dissipation.

8. The GEP of claim 1, wherein the GEP is configured to be installed at an edge of the utility grid, and the FPGA and GPU are provided on a same board.

9. The GEP of claim 1, wherein the GPU is configured to run one or more applications that are remotely controlled and/or receive input from the remote system.

10. A utility grid monitoring system comprising the GEP of claim 1 and the one or more sensors, wherein the one or more sensors include an optical voltage sensor.

11. A Grid Edge Platform (GEP) configured to monitor a utility grid, comprising:
at least one processor configured to process data in-situ;
at least one memory configured to store data in-situ, including processed data; and
a graphics processing unit (GPU) configured to execute at least one machine learning algorithm on the stored data and to run at least one application, the at least one application configured to be controlled by a remote system.

12. The GEP of claim 11, wherein the at least one processor includes a field-programmable gate array or a floating point gate array (FPGA) configured to manage the acquired data and to execute at least one algorithm using the acquired data.

13. A utility grid monitoring system including a plurality of sensors and the GEP of claim 11, wherein the GEP is configured to change power output to the utility grid based on a determination by the GPU.

14. A utility grid monitoring system, comprising:
a plurality of sensors deployed in a utility power distribution grid, wherein the plurality of sensors are configured to detect one or more parameters of the utility grid at one or more monitoring locations;
a Grid Edge Platform (GEP) configured to:
acquire data, including the one or more parameters;
process the acquired data;
store the processed data in memory, in-situ, for grid monitoring applications; and
provide the processed data to a GPU for machine learning applications.

15. The utility grid monitoring system of claim 14, wherein the GEP is configured to determine voltage, current, and phase at each monitoring location from the acquired data.

16. The utility grid monitoring system of claim 14, wherein the GEP is configured to process and output the determined voltage and current within Distributed Network Protocol (DNP) and IEC-61850 protocols.

17. The utility grid monitoring system of claim 14, wherein the GEP is configured for at least one of fault detection, anomaly detection, balancing, and/or grid optimization of the utility power distribution grid.

18. The utility grid monitoring system of claim 14, wherein the GEP is configured to be installed at a pole connected to a power line, and at least one of the plurality of sensors is configured to detect one or more parameters from the power line and/or from an underground component of the utility grid.

19. The utility grid monitoring system of claim 14, wherein the plurality of sensors include one or more fast sensors, optical sensors, voltage sensors, optical voltage sensors, vibration sensors, temperature sensors, resistive dividers, capacitive sensors, global positioning systems (GPS), and/or weather sensors.

20. The utility grid monitoring system of claim 14, wherein the plurality of sensors include a plurality of line hanging sensors adapted to be connected to the utility grid, and the system further comprises:
a fiber-optic cable configured to connect the line hanging sensors; and
an enclosure configured to be mounted on a utility pole or tower, wherein the enclosure is configured to house the GEP.
